(19) United States
(12) Patent Application Publication
(10) Pub. No.: US 2023/0311066 A1
(43) Pub. Date: Oct. 5, 2023

(54) FILTRATION SYSTEM

(71) Applicants: James Brown, Midway, UT (US); Tayler Norman Biehn, West Haven, UT (US); Jacob Tyler Adams, Orem, UT (US); Colten Gene Yardley, Provo, UT (US); Jacob Denney Eames, Snohomish, WA (US)

(72) Inventors: James Brown, Midway, UT (US); Tayler Norman Biehn, West Haven, UT (US); Jacob Tyler Adams, Orem, UT (US); Colten Gene Yardley, Provo, UT (US); Jacob Denney Eames, Snohomish, WA (US)

(73) Assignee: James Brown, Midway, UT (US)

(21) Appl. No.: 18/128,175

(22) Filed: Mar. 29, 2023

Related U.S. Application Data
(60) Provisional application No. 63/325,391, filed on Mar. 30, 2022.

(51) Int. Cl. B01D 61/16; B01D 29/27; B01D 61/14; B01D 39/16; B01D 29/56

(52) U.S. Cl. CPC B01D 61/16; B01D 29/27; B01D 61/147; B01D 39/16; B01D 29/56; B01D 2201/40; B01D 2201/18

(57) ABSTRACT

A filtration system includes a pre-filter device configured to strain contaminants from liquid. The pre-filter device includes a strainer body, a strainer sleeve secured to the strainer body, and a fastener configured to pass through the strainer sleeve to secure the pre-filter device to a container.

### RELATED APPLICATION

This application claims benefit of U.S. Provisional Application No. 63/325,391, filed Mar. 30, 2022, the entire contents of which are incorporated by reference in their entirety.

### TECHNICAL FIELD

Embodiments of the present disclosure relate to systems, and in particular to filtration systems.

### BACKGROUND

Water is used for drinking, cooking, sanitation, and so forth. Some water sources include contaminants. Filters are used to remove some of the contaminants from water.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-K illustrate components of filtration systems, according to certain embodiments.

FIG. 2 illustrates a flow diagram associated with manufacturing a pre-filter device of a filtration system, according to certain embodiments.

FIGS. 3A-P illustrate components of a pre-filter device, according to certain embodiments.

FIG. 4 illustrates a flow diagram associated with use of a pre-filter device of a filtration system, according to certain embodiments.

FIGS. 5A-H illustrate use of a pre-filter device, according to certain embodiments.

FIGS. 6A-P illustrate fasteners of pre-filter devices of filtration systems, according to certain embodiments.

FIGS. 7A-O illustrate filtration systems, according to certain embodiments.

FIGS. 8A-F illustrate graphs associated with filtration systems, according to certain embodiments.

FIG. 9 is a block diagram illustrating a computer system, according to certain embodiments.

### DETAILED DESCRIPTION OF EMBODIMENTS

Embodiments described herein are related to filtration systems.

Water is an essential part of life. Unfortunately, many places in the world do not have a reliable source of clean water. There is a lack of reliable source of clean water in some rural environments, some remote areas, in some under-developed areas, in some areas of outdoor recreation (e.g., hiking, backpacking, camping, fishing, hunting, etc.), and in some disaster zones.

Hundreds of millions of people across the globe live without access to safe water. Women and children are disproportionately affected by the water crisis, as women and children are often responsible for collecting water, which takes time away from work, school, play, and caring for family. In 2017, an estimated 2.2% of global deaths were a result of unsafe water sources. Time spent gathering water or seeking safe sanitation accounts for billions in lost economic opportunities. Access to safe water and sanitation gives families more time to pursue education and work opportunities that will help them break the cycle of poverty.

The conventional gathering of water from shallow water sources (e.g., surface water) is prone to contamination and pollution. The conventional bucket-and-rope system to retrieve water from underground (e.g., from a borehole or well) is prone to contamination (e.g., from unwashed hands touching the bucket and/or rope) and pollution (e.g., pollutants falling into the borehole or well). Travelling to other types of water sources that are further away requires much time and energy.

Conventionally, a small hand-held water filter may be used to filter some contaminants from water (e.g., water from shallow water sources, boreholes, wells, etc.). Some conventional filters are used to filter small contaminants. As a conventional filter is used, contaminants build up in the conventional filter and the flow rate through the conventional filter lowers until the conventional filter is unusable. Removing of built-up contaminants from inside conventional filters is complicated, time consuming, and uses clean water. This leads to conventional filters being abandoned or discarded and results in using unsafe water (e.g., unfiltered water, water that has not been reliably filtered) for consumption and sanitation.

The devices, systems, and methods of the present disclosure provide filtration systems that help solve these and other problems of conventional systems.

In some embodiments, a filtration system includes a container, a pre-filter device secured to an upper portion of the container, a conduit secured to a lower portion of the container, and a filter secured to the conduit.

The pre-filter device is configured to strain contaminants from liquid. The pre-filter device includes a strainer body, a strainer sleeve secured to the strainer body, and a fastener configured to pass through the strainer sleeve to secure the pre-filter device to a container.

Liquid (e.g., unfiltered water, contaminated water) is poured into the container through the pre-filter device to generate pre-filtered liquid. The pre-filtered liquid drains through the conduit to the filter and filtered liquid flows out of the filter. Larger contaminants (e.g., about 5 microns in width and greater) are removed from the liquid by the pre-filter device and smaller contaminants (e.g., about 0.1 to about 5 microns in width) are removed from the liquid by the filter device.

The systems, devices, and methods of the present disclosure have advantages over conventional solutions. The filtration system of the present disclosure provides cleaner water at higher flow rates compared to conventional solutions. The filtration system of the present disclosure provides more clean water with less maintenance and less downtime compared to conventional solutions.

Although certain embodiments of the present disclosure describe filtration systems including a pre-filter device attached to a container, in some embodiments, filtration systems of the present disclosure may include a pre-filter device that is integral to a container, used without a container, etc.

Although certain embodiments of the present disclosure describe filtration systems including a pre-filter device attached to a container that is a bucket, in some embodiments, filtration systems of the present disclosure may include a container that is a backpack, a bottle, a barrel, a cup, etc.

Although certain embodiments and/or figures of the present disclosure may illustrate exemplary dimensions of components and features of the present disclosure, the dimensions are examples and actual dimensions may be different than those described and/or shown.

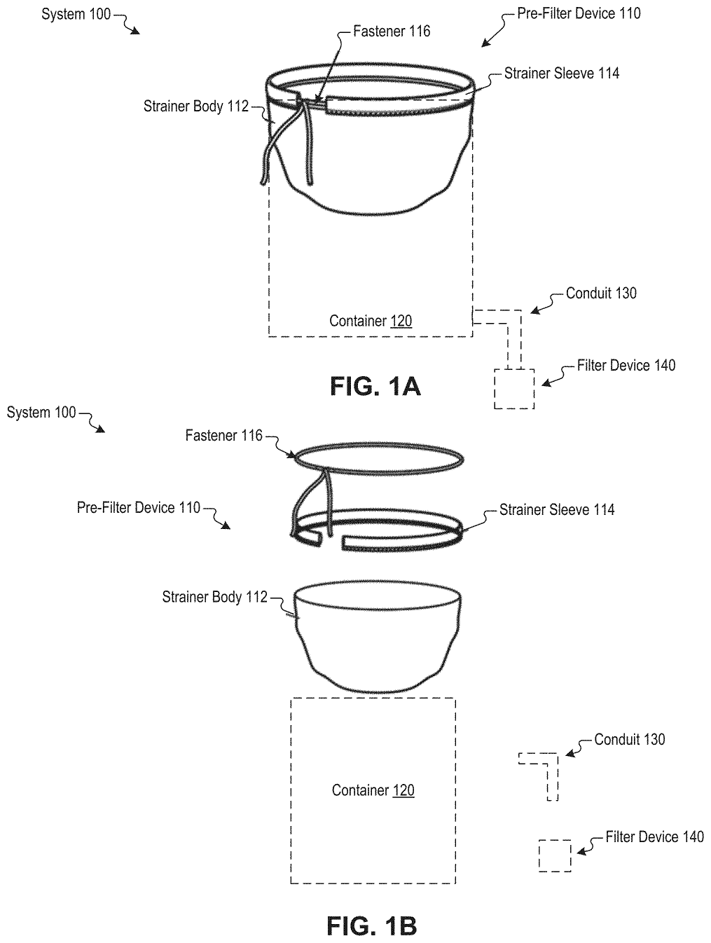

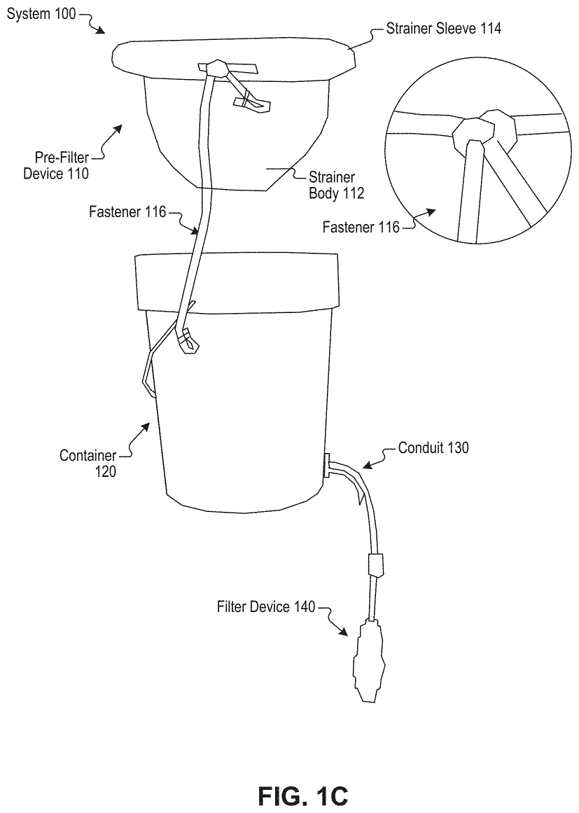

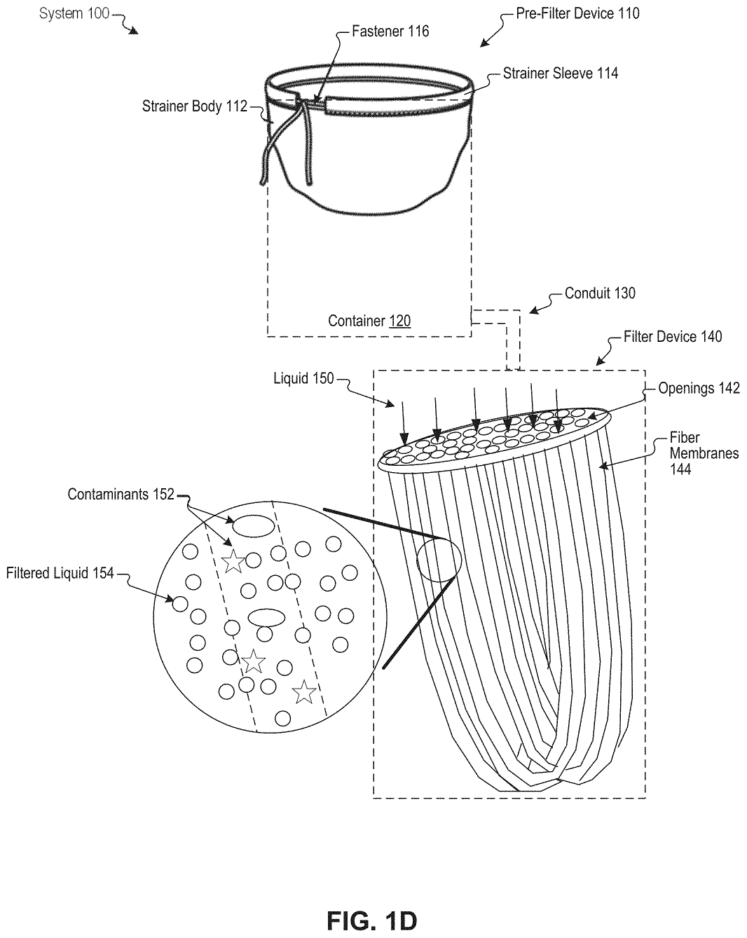

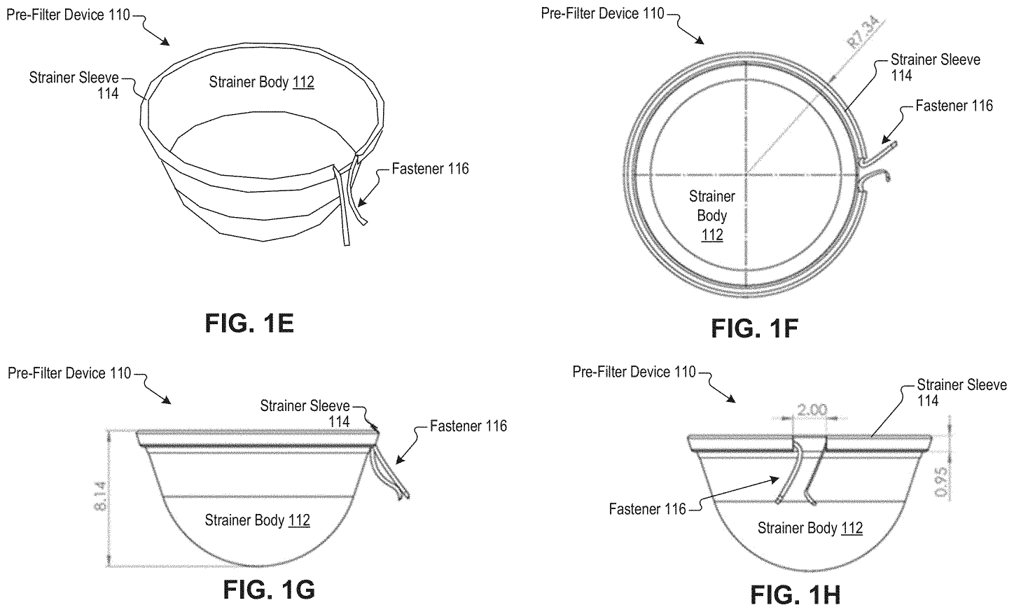

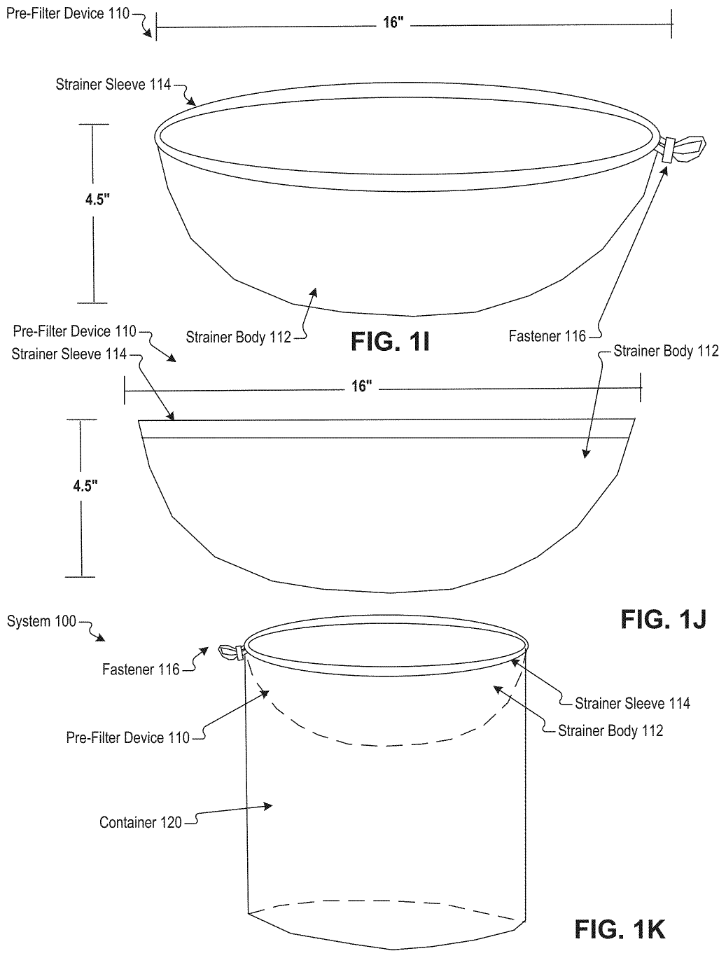

FIGS. 1A-K illustrate systems 100 (e.g., filtration systems), according to certain embodiments. FIG. 1A illustrates an assembled view and FIG. 1B illustrates an exploded view.

A system 100 may include a pre-filter device 110, a container 120, a conduit 130, and/or a filter device 140.

In some embodiments, pre-filter device 110 includes a strainer body 112, a strainer sleeve 114 (e.g., strainer top sleeve) secured to the strainer body 112, and a fastener 116 configured to pass through the strainer sleeve 114 to secure the pre-filter device 110 to a container 120. In some embodiments, pre-filter device 110 is a sediment pre-strainer configured to be fitted on a container 120 (e.g., a 5-gallon bucket or bucket of similar size) to strain out large contaminants (e.g., large particulates). The pre-filter device 110 removes at least a portion of contaminants in liquid to prolong the life of filter device 140 and to allow system 100 (e.g., filter device 140) to have a substantially consistent flow rate. The strainer body 112 (e.g., a durable material) and fastener 116 (e.g., fitting system) allows the pre-filter device 110 to work with various sizes of containers 120 (e.g., buckets of different diameters). In some embodiments, pre-filter device 110 is a fabric pre-filter cover for a container 120 (e.g., bucket) that strains solids from liquid before the liquid reaching filter device 140 that is fluidly coupled to the lower portion of the container 120.

In some embodiments, the strainer body 112 includes the filtering portion (e.g., straining surface) of the pre-filter device 110. In some embodiments, there is no stitching on the filtering portion of the pre-filter device 110. In some embodiments, stitching of the pre-filter device is reinforced (e.g., glued seam, bonding on seam, sealing on seam, epoxy on seam, plastic cage with stitching in cage, etc.) at least on the filtering portion of the pre-filter device 110. In some embodiments, the stitching of the pre-filter device 110 is a single stitch. In some embodiments, the stitching of the pre-filter device 110 is a double stitch. In some embodiments, the pre-filter device 110 is stitched with a standard stretch thread.

In some embodiments, the strainer body 112 is a circular shape that bulges when filled with water to create a pseudo-half-sphere shape.

In some embodiments, an increased depth of the pre-filter device 110 (e.g., strainer body 112) sits in the container 120 provides an increased flow rate (e.g., increase in hydrostatic pressure as the strainer body 112 is deeper in the container 120) and uses a decreased physical effort to use the pre-filter device 110 (e.g., less number of pours of liquid into the system 100 to empty a 5-gallon bucket and less amount of time to filter liquid through the system 100, due to increase in flow rate from a deeper strainer body 112 and an increase in volume of liquid that the strainer body 112 can hold at a point in time).

Depth testing results are shown in Table 1:

| Depth | Time to | Time to | |
|---|---|---|---|
| (in) | Empty Bucket | Zero Flow | Description |
| 4 | 16:02 | 24:11 | Arbitrary time to zero flow because |
| | | | the test took so long to reach the |
| | | | threshold |
| 5 | 9:57 | 27:41 | Less than 10 minutes to empty the |
| | | | bucket but almost 30 min to drain |
| 6 | 4:58 | 18:01 | — |
| 7 | 2:04 | 10:27 | — |
| 8 | 0:44 | 5:07 | Less than 1 minute to empty |
| | | | bucket into strainer |

In some embodiments, pre-filter device 110 has a depth (e.g., depth from lip of container 120 to bottom of strainer body 112) of about 4 to about 10 inches, of about 6 to about 8 inches, of at least about 8 inches, and/or the like.

In some embodiments, the pre-filter device 110 fits around about 10 to about 16 inch diameter container, has about 8 inch depth within the container 120, supports at least 30 lbs of liquid, and/or has no liquid interface with stitching of the pre-filter device 110.

In some embodiments, the pre-filter device 110 is made of nylon mesh that has openings of about 30 microns or less (e.g., openings of the nylon mesh are no greater than 30 microns in width), about 25 microns or less, about 20 microns or less, about 15 microns or less, about 10 microns or less, about 5 microns or less, about 4 microns or less, and/or the like.

In some embodiments, the fastener 116 is a cord. In some embodiments, the fastener 116 is an elastic cord. In some embodiments, the fastener 116 includes one or more elastic strands forming a core. In some embodiments, the core of the fastener 116 is covered in a woven cotton or polypropylene sheath (e.g., that does not materially extend elastically, braided with strands spiraling around the core so that a longitudinal pull causes the sheath to squeeze the core, transmitting the elastic compression of the core to the longitudinal extension of the sheath and cord). In some embodiments, the fastener 116 is a bungee cord (e.g., bungie cord, shock cord).

In some embodiments, container 120 includes one or more of a bucket, a barrel, a tank (e.g., 55 gallon tank or the like), a bottle, a backpack, a cup, a tube, etc. In some embodiments, container 120 includes a liquid container made from metal (e.g., pressed steel) or plastic (e.g., high density polyethylene). In some embodiments, container 120 is a jerrycan (e.g., jerrican). In some embodiments, container 120 has one or more straps (e.g., to carry the container 120 on the back of an individual) or one or more handles (e.g., to carry the container 120 by hand).

Container 120 may have walls that partially enclose an inner volume. The walls may include a bottom wall and one or more sidewalls. The container 120 may have an upper portion (e.g., lip) that forms an upper opening and a lower portion that forms a lower opening (e.g., opening in a sidewall of the container 120). The pre-filter device 110 is configured to secure to the upper portion of the container 120 at the upper opening (e.g., secure to the lip of the container 120 so that liquid flows through the pre-filter device 110 and the upper opening formed by the container 120 into the container 120). The conduit 130 is configured to secure to the lower portion of the container 120 at the lower opening (e.g., secure to the sidewall of the container 120 so that liquid flows from the container 120, through the opening in the sidewall of the container, and through the conduit 130).

In some embodiments, conduit 130 includes one or more of a tube, a pipe, hose, a structure forming a channel, an attachment, etc. The conduit 130 is disposed downstream of the container 120. The conduit 130 is disposed upstream of the filter device 140. In some embodiments, the conduit 130 is connected to a port at a lower portion of a container 120 (e.g., the bottom of a 5-gallon bucket).

The filter device 140 is configured to attach to the conduit 130. The filter device 140 filters smaller contaminants from liquid than the pre-filter device 110. In some embodiments, filter device 140 provides filtered water (e.g., for consumption, for sanitation, etc.). In some embodiments, filter device 140 is rated as a “0.1” micron absolute and deters 100% of microbes larger than 0.1 microns in width from entering the filtered water.

In some embodiments, two or more filter devices 140 are coupled to the container 120 via one or more conduits 130 (e.g., each filter device 140 has a corresponding conduit 130 that connects to container 120). The filter device 140 is configured to attach to the conduit 130.

In some embodiments, filter device 140 is a 0.1-micron water purifying filter and pre-filter device 110 is a sediment strainer that acts as a pre-filter to improve the amount of liquid (e.g., dirty water) used before clogging the filter device 140. In some embodiments, liquid gravity drains through the filter device 140 and the filter device 140 removes suspended solids from the liquid down to a colloid and/or fine clay level and also removes harmful bacteria.

In some embodiments, filter device 140 includes one or more of hollow fiber membranes made of small U-shaped micro tubes where water enters cores of the U-shaped micro tubes through micro pores that are 0.1-micron absolute (e.g., 0.1 microns in width), granular-activated carbon filter (GAC) used for carbon filtering, depth filter, metallic alloy filter, microporous ceramic filter, carbon block resin (CBR), microfiltration and/or ultrafiltration membranes, ultraviolet light filter, chlorine additive filter, chlorine dioxide additive filter, iodine (e.g., iodine crystal) additive filter, sodium hypochlorite (e.g., bleach) additive filter, reverse osmosis filters, activated charcoal adsorption filter, halazone tablet filter, mixed oxidant (MiOx) filter, silver ion additive filter, hydrogen peroxide additive filter, solar water disinfection filter, solar distillation filter, and/or the like.

In some embodiments, pre-filter device 110 is configured to remove one or more of sand (e.g., beach sand), granular activated carbon, ion exchange resin bead, humic acids, tannic acids, folic acids, bacteria, suspended solids, whey proteins, yeast cells, silt, glacial till, rock flour, water-oil emulsions, parasites, and/or the like.

In some embodiments, filter device 140 is configured to remove one or more of sand (e.g., beach sand), granular activated carbon, ion exchange resin bead, humic acids, tannic acids, folic acids, bacteria, suspended solids, whey proteins, yeast cells, silt, glacial till, rock flour, water-oil emulsions, parasites, viruses, colloids, clay, gelatin, and/or the like.

The filter device 140 may include an inlet port and an outlet port. The inlet port of the filter device 140 may be fluidly coupled (e.g., connected, attached, fastened) to the conduit 130. In some embodiments, the filter device 140 and/or conduit 130 includes a valve (e.g., filter valve) to prevent and allow fluid flow through the filter device 140. Responsive to the filter device 140 reaching a steady state flow or the fluid flow drops below a threshold flow rate, the valve is closed (e.g., and the filter device 140 is removed for backflushing of the filter device 140. A syringe of water (e.g., clean water) may be inserted into the outlet port of the filter device 140 and water is pushed by the syringe into the outlet port and out of the inlet port. This is referred to as backflushing. Backflushing is continued until the water exiting the inlet port is substantially clear. The valve is then opened (e.g., and the filter device 140 is attached to the conduit 130). The filter device 140 may be connected to the conduit 130 while water is flowing through the conduit 130 to allow the conduit 130 to be flooded to not input additional air bubbles into the filter device 140.

In some embodiments, pre-filter device 110 is simple to use, has strainer instructions that are easy to understand, is easy to clean, is durable, is cost effective, can extend life of filter device 140, reduces clogging of filter device 140, is compact and foldable (e.g., to be placed in a shipping bag), allows system 100 to provide filtered liquid at a higher flow rate than conventional systems (e.g., provides adequate flow rate), adjusts to multiple sizes of buckets, is callable and repeatable.

In some embodiments, pre-filter device 110 has a low time for set-up, has lower time to clean after use, is configured to support a suspended liquid volume, is made of a fabric that is weight-bearing, has fabric and stitching that is resilient, has a low manufacturing cost, provides pre-filtered liquid that has contaminants of a small particulate size, is compact (e.g., responsive to being folded), has a high flow rate of liquid through the pre-filter device 110, is configured to be used with containers 120 of different diameters, and is one unit (e.g., no separate parts).

In some embodiments, pre-filter device 110 is configured to filter at least a threshold amount of liquid (e.g., one-fourth cup of dirt mixed into four gallons of tap water) before clogging filter device 140 (e.g., 0.1-absolute micron filter). In some embodiments, the threshold amount is at least about 6 gallons of liquid, at least about 8 gallons of liquid, at least about 10 gallons of liquid, at least about 15 gallons of liquid, at least about 20 gallons of liquid, at least about 21.71 gallons of liquid, about 6-8 gallons, about 8-10 gallons, about 10-15 gallons, or the like.

In some embodiments, system 100 is configured to provide filtered water (e.g., 0.1-absolute micron filter flow rate, flow rate of pre-filter device 110) at a threshold flow rate responsive to 10 gallons of filtered clean water. In some embodiments, the threshold flow rate is at least about 3 gallons per hour (gph), at least about 4 gph, at least about 5 gph, at least about 6 gph, at least about 6.3 gph, at least about 8 gph, about 4-5 gph, about 5-6 gph, about 6-8 gph, or the like.

In some embodiments, flow rate of liquid (e.g., one-fourth cup of dirt mixed into four gallons of tap water) through pre-filter device 110 meets a threshold flow rate. In some embodiments, the threshold flow rate is at least about 10 gph, at least about 20 gph, at least about 60 gph, at least about 80 gph, about 10-20 gph, about 20-60 gph, about 60-70 gph, at least 50 gph (e.g., average over the first 10 gallons filtered by system 100), at least 340 gph (e.g., for the initial 5 gallons filtered by system 100), and/or the like.

In some embodiments, pre-filter device 110 is configured to be setup (e.g., secured to container 120) within a threshold amount of time. In some embodiments, the threshold amount of time is at least about 30 seconds, at least about 15 seconds, at least about 5 seconds, at least about 3 seconds, about 3-5 seconds, about 5-15 seconds, about 15-30 seconds, or the like.

In some embodiments, the weight-bearing load of the pre-filter device 110 (e.g., fabric of the pre-filter device 110) is about 40 to about 200 pounds (lbs), about 40 to about 75 lbs, about 75 to about 200 lbs, and/or the like.

In some embodiments, pre-filter device 110 fits over containers 120 that have a diameter of about 10 to about 20 inches, about 8 to about 18 inches, about 10 to about 16 inches, about 12 to about 16 inches, about 12 to about 18 inches, and/or the like.

In some embodiments, pre-filter device 110 has folded dimensions of a width of about 5 to about 7 inches, a length of about 7 to about 9 inches, and/or a thickness of about half to about one inch.

In some embodiments, the pre-filter device 110 is one part that is lightweight and easily transported (e.g., shipped). In some embodiments, the pre-filter device 110 is constructed entirely of 5-micron nylon mesh (e.g., synthetic nylon mesh) with a sewn-in cotton drawstring and tightening button (e.g., at a distal end of the drawstring).

The pre-filter device 110 (e.g., strainer body 112) forms a bowl-shaped area that performs filtering. As liquid (e.g., dirty water) is poured through the strainer body 112 (e.g., nylon mesh area), the strainer body 112 filters out contaminants (e.g., particulates) larger than 5-microns (e.g., 1/14^{th} the diameter of a human hair, slightly smaller than a human red blood cell) in size.

The fastener 116 may be a tightening system that includes a bungee cord that has the ability to stretch to provide tension to hold the system 100 in place over a container 120 (e.g., bucket). The fastener 116 may form a slip knot (e.g., be tied in a slip knot) to provide friction to keep the bungee cord from loosening while in place. Fastener 116 may allow the system 100 to be stretched over a container 120 that has a diameter of up to 16-inches while also being able to tighten over containers 120 that are as small as about 10-inches in diameter.

The strainer body 112 and/or strainer sleeve 114 may be made of 5-micron nylon mesh fabric. 5-micron nylon mesh fabric may be made by tightly weaving nylon together. Each thread is a single filament and the openings formed by the fabric are square. The term “5-micron” classifies the size of particle that can pass through the fabric.

The fastener 116 may be a bungee cord with a slip knot. The fastener 116 may be a nylon-coated bungee cord that has a slip knot tied on one end of the cord with the other end being fed through.

In some embodiments, the strainer body 112 and/or strainer sleeve 114 are made of one or more materials that are configured for commercial food grade filtration. In some embodiments, the strainer body 112 and/or strainer sleeve 114 are made of one or more of nylon mesh or polyester felt.

A pre-filter device 110 that includes polyester felt (e.g., strainer body 112 and/or strainer sleeve 114 are made of polyester felt) may be one or more of 0.5-micron filter rating, provide visually clearer filtered water than other fabrics, maintain higher flow rates when dirty compared to other fabrics, and/or the like.

A pre-filter device 110 that includes nylon mesh (e.g., strainer body 112 and/or strainer sleeve 114 are made of nylon mesh) may be one or more of easy to clean compared to other fabrics, more durable compared to other fabrics, not degrade filter pore size responsive to cleaning, lighter and thinner than other fabrics, configured to meet flow rates at lower pressures than other fabrics, and/or the like.

In some embodiments, system 100 (e.g., pre-filter device 110) is one or more of a gravity-drained system, a mechanical hand-powered pump filtration system, a pressurized fabric vessel filtration system, and/or the like. In some embodiments, pre-filter device 110 includes a single-layer nylon mesh strainer that fits over the top of a container 120 (e.g., bucket).

In some embodiments, the pre-filter device 110 is a 5-micron nylon mesh that is configured to attach to a rim of a container 120 (e.g., bucket, to which filter device 140 is connected) to hold and strain liquid (e.g., dirty water). The 5-micron nylon mesh may be cleaned and may produce water quality that improves the life of the filter device 140 (e.g., 0.1-micron filter). In some embodiments, the strainer body 112 is a dome shape (e.g., formed without sewing). Responsive to being secured to a container 120, the pre-filter device 110 may have a depth of about 8 inches to increase hydrostatic pressure to force water through the pre-filter device 110 and/or filter device 140, hold a greater amount of water than smaller depths, cut down on operator time (e.g., can pour greater amounts of water into system 100 at once), and/or the like.

The fastener 116 may include a tightening mechanism and a securing mechanism. In some embodiments, the fastener 116 is a drawstring with a button, where the button is the tightening mechanism and the drawstring is the securing mechanism. In some embodiments, the fastener 116 is a tied bungee cord (e.g., about ¼ inch diameter bungee cord), where the slipknot is the tightening mechanism and the bungee cord is the securing mechanism. Use of a knot (e.g., slipknot) reduces potential of damage of the system 100.

In some embodiments, the strainer sleeve 114 and strainer body 112 are made from the same sheet of material (e.g., sheet of 5-microrn nylon mesh). In some embodiments, the strainer sleeve 114 and strainer body 112 are made from different materials (e.g., the strainer sleeve 114 is a more durable material than the material of the strainer body 112, the strainer sleeve 114 has a coating, etc.). The strainer sleeve 114 may protect the fastener 116 from ultraviolet (UV) exposure and may protect the pre-filter device 110 (e.g., responsive to continuous use of rubbing against container 120).

In some embodiments, the system 100 is used to filter liquid via circulating of particles. This refers to pouring water which dislodges particles that could be clogging the pre-filter device 110. By keeping the depth of the pre-filter device 110 short, momentum of the liquid suspends particles which would have started to develop in a sediment layer which would slow down flow.

Flow rate of system 100 may refer to the volumetric flow rate (e.g., gph) at which water is flowing out of filter device 140. Gravity fed may refer to using gravity to apply pressure to liquid in system 100. Head may refer to the water pressure used to push liquid through the pre-filter device 110 and/or filter device 140. Head may be measured in inches. Mechanical pressure may refer to the use of human work to add pressure to the system 100 (e.g., by squeezing). Nylon mesh may refer to the type of material used for filtering capabilities (e.g., may be specified by the filtering size). Polyester felt may refer to a type of material used for filtering capabilities. Polyester felt may have a Polytetrafluoroethylene (PTFE) coating. Sediment layer (e.g., media layer, mud cake layer, etc.) may refer to particles that have been filtered out of the liquid that are building up and creating a layer of dirt and debris on top of the strainer body 112 of the pre-filter device 110. Squeezed may refer to substantially sealing the pre-filter device 110 and then squeezing the pre-filter device 110 to increase head for water pressure. Suspended may refer to a pre-filter device 110 that is hung from a structure above a container 120.

FIG. 1C is a perspective view of system 100. In some embodiments, fastener 116 is a cord that is tied. In some embodiments, filter device 140 has micro-tubes used to filter liquid.

FIG. 1D illustrates a system 100 including the pre-filter device 110 secured to container 120, where a conduit 130 is disposed between container 120 and filter device 140.

In some embodiments, filter device 140 is a hollow fiber membrane filter (e.g., includes hollow fiber membranes 144) that is used to produce filtered liquid 154 (e.g., bacteria-free water). The filter device 140 may include hollow fiber membranes 144 (e.g., small spaghetti-like hollow tubes) that catch contaminants 152 (e.g., sediment or bacteria) larger than 0.1 microns in size (e.g., E. Coli and similar bacteria are approximately 3 microns or bigger in size). Liquid 150 (e.g., water) enters the filter device 140 via openings 142 formed by an upper portion of the filter device 140. Contaminants 152 (e.g., bacteria) stays in the fiber membranes 144 (e.g., tubes), not moving through the pores formed by the fiber membranes 144. Liquid 150 (e.g., water) passes through the pores out of the fiber membranes 144 (e.g., hollow fibers) to the output opening of the filter device 140. If water containing lots of suspended particles is filtered, the fiber membranes 144 become filled with small sediment particles and the flow rate through the filter device 140 decreases.

In some embodiments, filter device 140 is to be backflushed by taking a syringe of clean water and power flushing in reverse direction through the filter device 140 to remove contaminants (e.g., sediment) and to restore the filter device 140 to previous flow rates.

FIGS. 1E-H are views of a pre-filter device 110 of system 100. FIG. 1E is a top perspective view, FIG. 1F is a top view, FIG. 1G is a front view, and FIG. 1H is a side view.

In some embodiments, strainer body 112 is a 5-micron nylon mesh (e.g., has openings that are 5-microns or smaller in width). Strainer body 112 may have no seams (e.g., is one continuous piece of material). In some embodiments, fastener 116 is a one-fourth inch nylon-protected bungee cord (e.g., contained by strainer sleeve 114). In some embodiments, strainer sleeve 114 is nylon mesh material (e.g., same type of material as the strainer body 112) that is folded back and seamed around the perimeter.

In some embodiments, the 5-micron nylon mesh is folded outwards back onto strainer body 112. In some embodiments, at least one-inch of overlap between the 5-micron nylon mesh material is sewn back onto the strainer body 112 (e.g., double stitching around perimeter of the strainer body 112 and strainer sleeve 114).

In some embodiments, responsive to being secured to a container 120, the pre-filter device 110 has a height of about 6 to about 10 inches (e.g., about 8.14 inches) and a radius of about 5 to about 9 inches (e.g., about 7.34 inches), the strainer sleeve 114 has a height of about 0.5 to about 2 inches (e.g., about 0.95 inches), and there is about a 0.5 to about 4 inch (e.g., about 2 inch) gap between distal ends of the strainer sleeve 114 (e.g., responsive to being sewn to the strainer body 112).

FIGS. 1I-K are views of a pre-filter device 110 of system 100. FIG. 1I is a top perspective view of a pre-filter device 110, FIG. 1J is a front view of a pre-filter device 110, and FIG. 1K is top perspective view of a system 100 including a pre-filter device 110. Dimensions shown are exemplary and pre-filter devices 110 of other dimensions may be used.

The pre-filter device 110 may be a sediment pre-filter and may have a bowl-shaped design. A fastener 116 (e.g., drawstring tightening system) may be disposed around an upper rim (e.g., strainer sleeve 114) of the pre-filter device 110. In some embodiments, pre-filter device 110 is shaped like a large serving bowl that fits snuggly on the top of a container 120 (e.g., bucket) with the bottom of the bowl sitting about 3 inches below the rim of the container 120, where the bowl is made from a fabric (e.g., 5-micron nylon mesh). The fastener 116 (e.g., drawstring) allows the pre-filter device 110 to be fitted over containers 120 (e.g., buckets) ranging from about 10 inches to about 16 inches in diameter and pulled tight to self-hold in place.

In some embodiments, the upper portion (e.g., strainer sleeve 114, upper about 1 inch of the nylon mesh) folds over the rim of the container 120 (e.g., bucket) and the fastener 116 (e.g., drawstring) is pulled tight to fasten the pre-filter device 110 firmly in place (e.g., see FIG. 1K). This allows pouring of liquid directly into the container 120, first passing through the pre-filter device 110 that removes contaminants (e.g., any particulates larger than 5-microns in size).

As shown in FIG. 1J, seam allowance on the strainer sleeve 114 (e.g., drawstring section) is about ¾ inch. This allows spaces for the fastener 116 (e.g., drawstring cord) to be threaded through the strainer sleeve 114 and still be able to easily adjust tightness. Although FIG. 1J shows about 16-inches in diameter, the fastener 116 can be pulled tighter to fit the pre-filter device 110 over (e.g., secure the pre-filter device 110 to) containers 120 (e.g., buckets) that have a dimeter as small as about 10 inches. When a container 120 that has a smaller diameter (e.g., a diameter less than about 16 inches), the fabric of the pre-filter device 110 (e.g., the strainer sleeve 114, the strainer body 112) is pulled further than about 1 inch over the rim of the container 120 (e.g., bucket). The pre-filter device 110 may be folded over the rim of the container 120 enough so that the bottom of the pre-filter device 110 (e.g. the center of the strainer body 112) is about 3 inches below the upper rim of the container 120.

In some embodiments, pre-filter device 110 is used for outdoors activities (e.g., hiking) and/or emergency preparedness. The pre-filter device 110 may fit on a portable filter (e.g., backpacking filter, iodine filter, etc.). The container 120 and filter device 140 may be combined into one device (e.g., a portable filter).

In some embodiments, the pre-filter device 110 is used with a container 120 that is a dry bag (e.g., a flexible container that seals in a watertight manner, a flexible container with straps to be worn like a backpack). In some embodiments, the dry bag has a port in the bottom that is fluidly coupled (e.g., attached) to a conduit 130 and/or filter device 140. In some embodiments, the pre-filter device 110 is attached (e.g., sewn) to the top of the dry bag. In some embodiments, the pre-filter device 110 is partially attached to the top of the dry bag. In some embodiments, the pre-filter device 110 is removably attached to the top of the dry bag. In some embodiments, the pre-filter device 110 can be stored in a pocket or sleeve of the dry bag. In some embodiments, the pre-filter device 110 attaches to one or more portions of the top of the dry bag via zipper, hook and loops (e.g., Velcro®), hooks, S loop hook, D-loop, and/or the like. In some embodiments, an upper portion of the dry bag forms a rim and the pre-filter device 110 secures to the rim via the fastener 116. In some embodiments, the dry bag is configured to be placed in running water (e.g. stream, river) or to be moved through water (e.g., lake, reservoir, pond, body of water, etc.) to pre-filter liquid into the dry bag (e.g., through pre-filter device 110) to avoid transporting sediment in the dry bag.

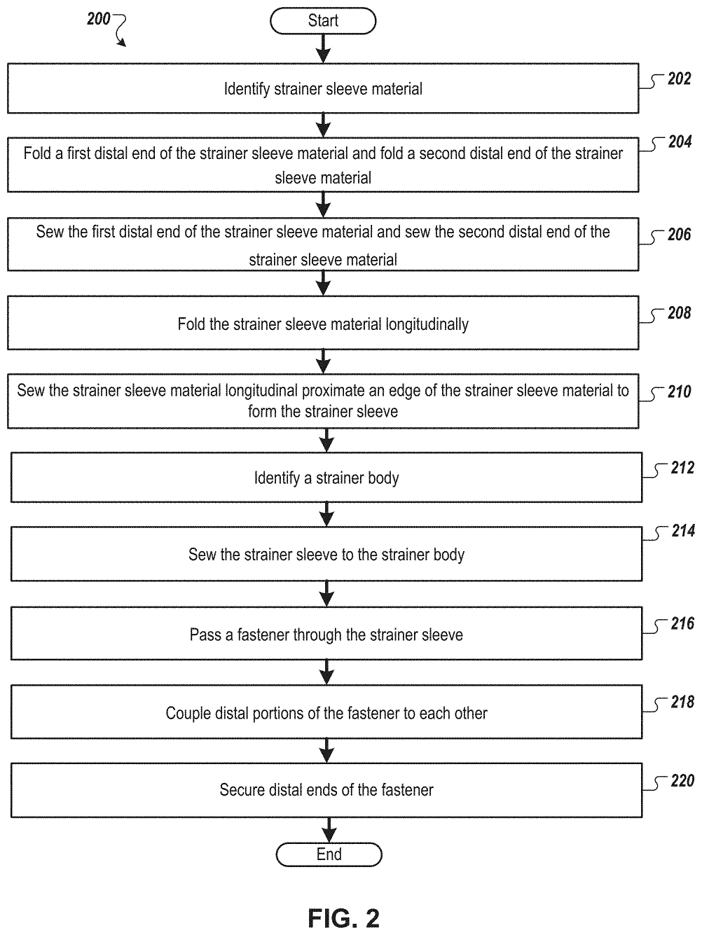

FIG. 2 illustrates a flow diagram associated with manufacturing a pre-filter device (e.g., pre-filter device 110 of FIGS. 1A-K) of a filtration system (e.g., system 100 of FIGS. 1A-K), according to certain embodiments.

In some embodiments, method 200 is performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 200 is performed by manufacturing system, a controller of a manufacturing system, a sewing device, a cutting device, one or more robots, a server device, a client device, and/or the like. In some embodiments, a non-transitory machine-readable storage medium stores instructions that when executed by a processing device, cause the processing device to perform method 200.

For simplicity of explanation, method 200 is depicted and described as a series of operations. However, operations in accordance with this disclosure can occur in various orders and/or concurrently and with other operations not presented and described herein. Furthermore, in some embodiments, not all illustrated operations are performed to implement methods 200 in accordance with the disclosed subject matter. In addition, those skilled in the art will understand and appreciate that methods 200 could alternatively be represented as a series of interrelated states via a state diagram or events.

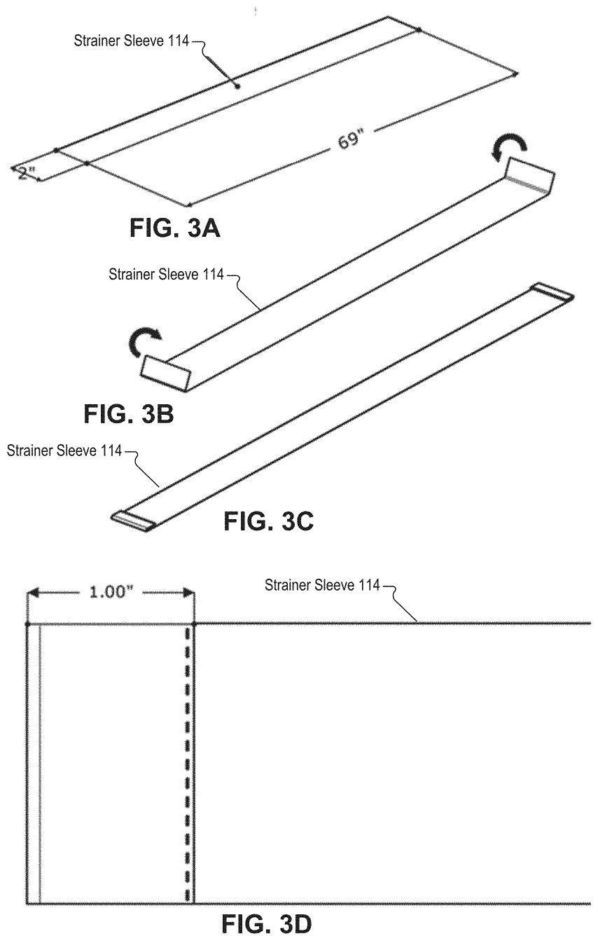

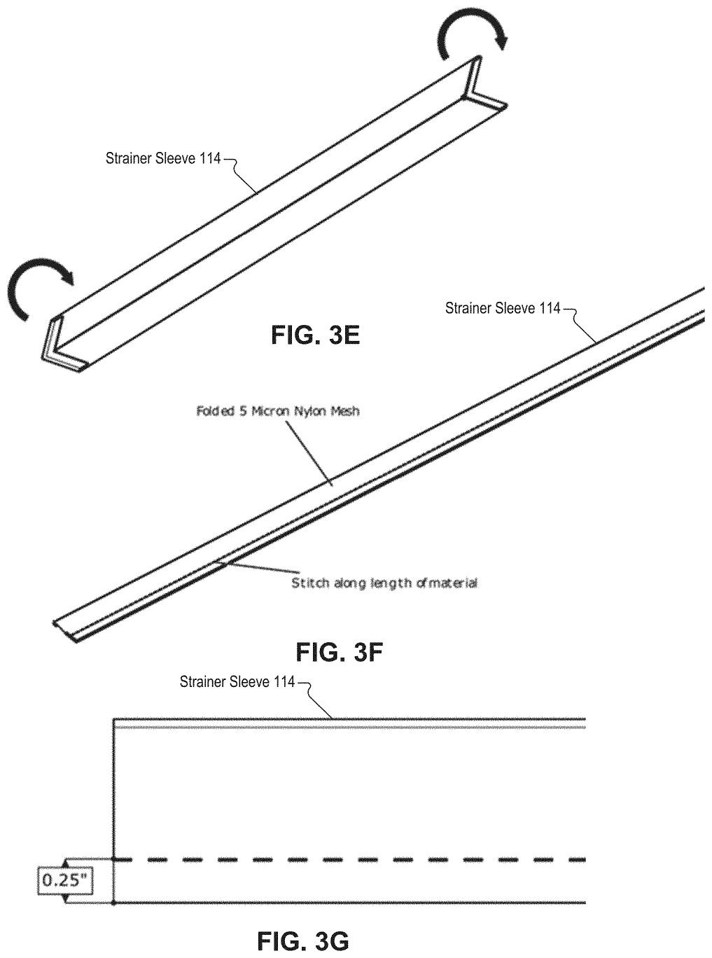

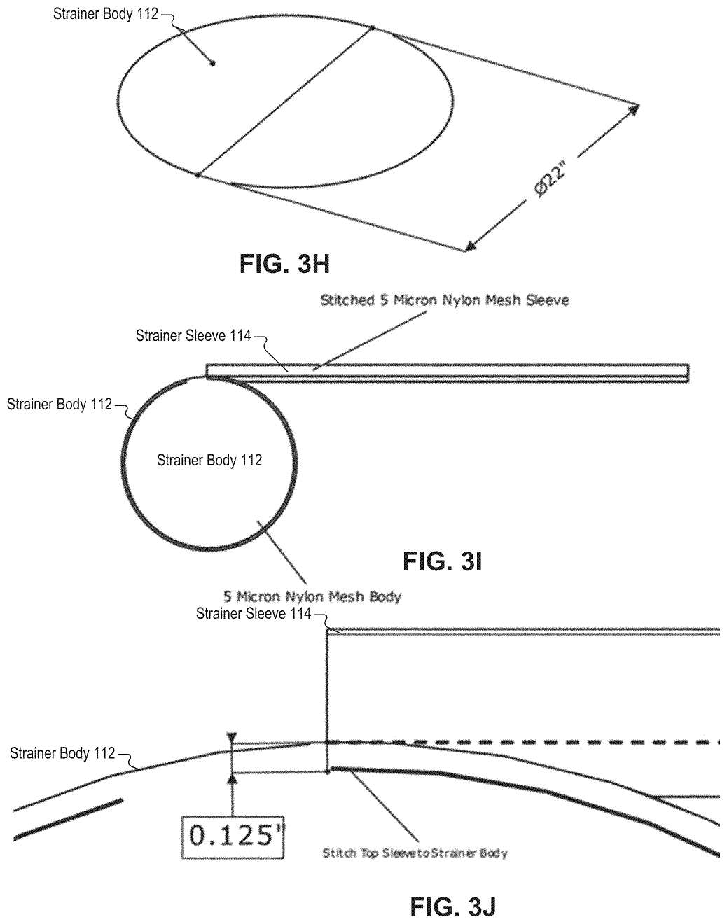

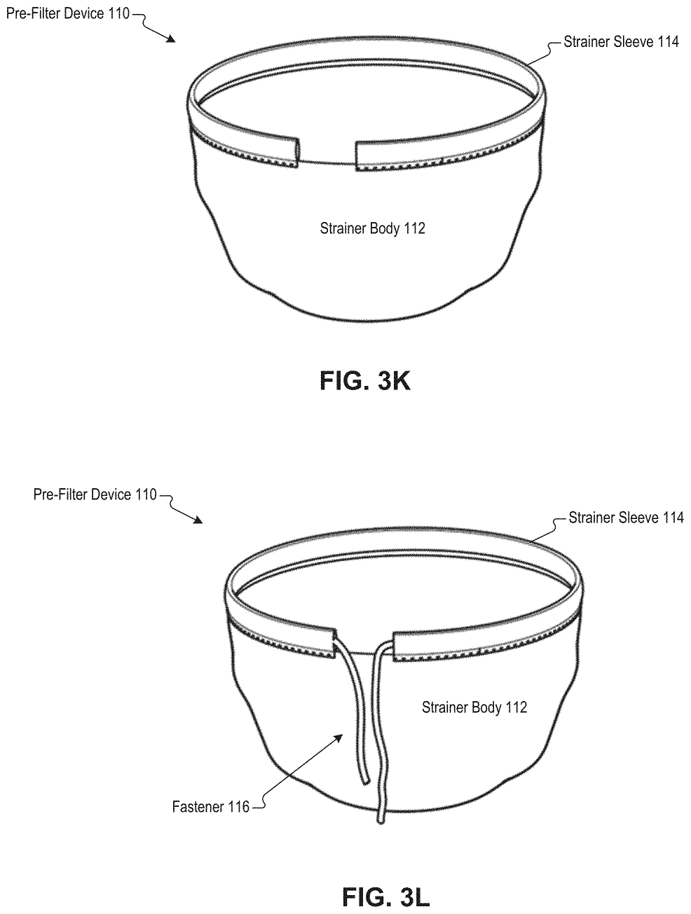

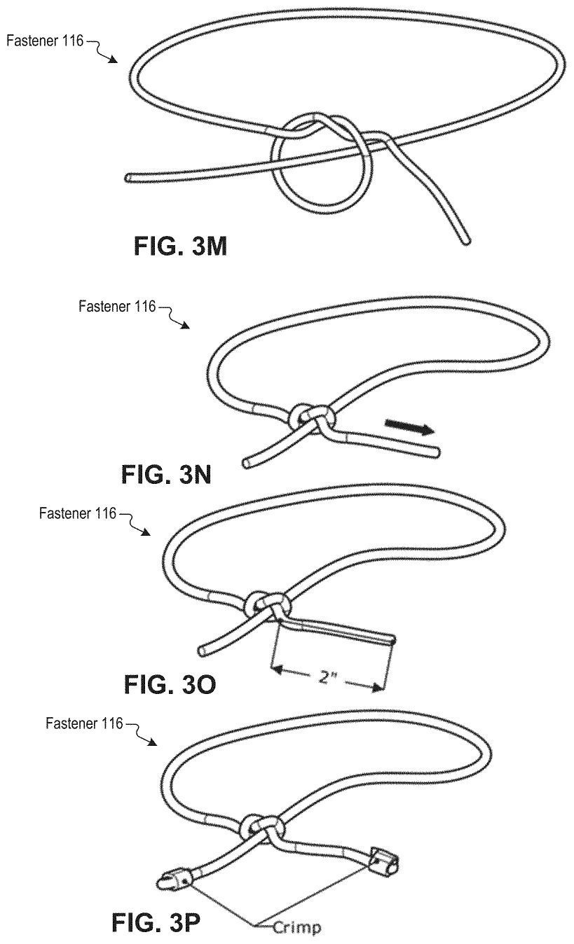

At block 202, strainer sleeve material is identified (e.g., see FIG. 3A). In some embodiments, the strainer sleeve material is cut from fabric (e.g., mesh, nylon mesh, 5-micron mesh). In some embodiments, the strainer sleeve material is about 60-80 inches (e.g., about 69 inches) long and about 1-4 inches (e.g., about 2 inches) wide.

At block 204, a first distal end of the strainer sleeve material and a second distal end of the strainer sleeve material are folded (e.g., see FIG. 3B).

At block 206, the first distal end of the strainer sleeve material is sewn and the second distal end of the strainer sleeve material is sewn (e.g., see FIGS. 3C-D). The distal ends may be sewn at about 0.25 to about 2 inches from the fold lines.

At block 208, the strainer sleeve material is folded longitudinally (e.g., see FIG. 3E).

At block 210, the strainer sleeve material is sewn longitudinally proximate an edge of the strainer sleeve material to form the strainer sleeve (e.g., see FIGS. 3F-G). The strainer sleeve material may be sewn at about 0.5 to about 1 inch (e.g., about 0.25 inches) from the edges.

At block 212, strainer body is identified (e.g., see FIG. 3H). In some embodiments, the strainer body is cut from fabric (e.g., mesh, nylon mesh, 5-micron mesh). In some embodiments, the strainer body is cut from the same sheet of fabric as the strainer sleeve material. In some embodiments, the strainer body is a circle that is about 15-30 inches (e.g., about 22 inches) in diameter.

At block 214, the strainer sleeve is sewn to the strainer body (e.g., see FIGS. 3I-K). In some embodiments, the strainer sleeve is sewn on the outside of the strainer body. In some embodiments, the strainer sleeve is sewn on the inside of the strainer body. In some embodiments, the strainer sleeve and the strainer body are sewn halfway between the open edges of the strainer sleeve and the longitudinal stitching of the strainer sleeve. In some embodiments, the strainer body and strainer sleeve are may be sewn at about 0.5 to about 2 inches (e.g., about 0.125 inches) from the edge of the strainer body.

At block 216, a fastener is passed through the strainer sleeve (e.g., see FIG. 3L). In some embodiments, the fastener is a ¼ inch diameter nylon wrapped bungee cord.

At block 218, distal portions of the fastener are coupled together (e.g., see FIGS. 3M-O). In some embodiments, the distal portions of the fastener are coupled together via a slip knot. In some embodiments, the distal end of the fastener is pulled about 1 to about 3 inches (e.g., about 2 inches) through the slip knot.

At block 220, distal ends of the fastener are secured (e.g., crimped, see FIG. 3P). In some embodiments, each distal end is secured via a crimp (e.g., zinc plated steel end crimp). In some embodiments, each distal end is crimped separately. In some embodiments, the distal ends are crimped together (e.g., the fastener forms a continuous loop).

FIGS. 3A-P illustrate manufacturing of a pre-filter device 110 of a system 100, according to certain embodiments. FIGS. 3A-P may be manufacturing instructions including folding and stitching of a strainer sleeve 114 in FIGS. 3A-G, assembly of strainer body 112 and strainer sleeve 114 in FIGS. 3H-K, and assembly of the fastener 116 (e.g., bungee) in FIGS. 3L-P.

Referring to FIG. 3A, strainer sleeve material is produced (e.g., a piece of fabric is cut) to be used to form the strainer sleeve 114. The piece of fabric may be about 69″ by about 2″. In some embodiments, strainer sleeve 114 starts by cutting about 2″ by about 69″ strip of 5-micron nylon mesh.

Referring to FIG. 3B, strainer sleeve material is folded at the distal ends. In some embodiments, about 1″ of the strainer sleeve material is folded about 1 inch towards a center of the strainer sleeve material.

Referring to FIGS. 3C-D, each distal end of the strainer sleeve material is sewn subsequent to being folded. Each distal end of the strainer sleeve material may be sewn about 1 inch from the distal end. In some embodiments, the about 1″ fold is stitched to the main material body of the strainer sleeve material.

Referring to FIG. 3E, the strainer sleeve material is folded longitudinally (e.g., the strainer sleeve material is folded along the length of the strainer sleeve material).

Referring to FIGS. 3F-G, the strainer sleeve material is sewn longitudinally (e.g., stitched along the length of the material) proximate an edge (e.g., opposite the longitudinally folded edge) to form the strainer sleeve 114. The distal ends of the strainer sleeve material are already folded and stitched. In some embodiments, the strainer sleeve material is stitched across the length of the strainer sleeve material. In some embodiments, the strainer sleeve material is stitched about 0.25″ from the open bottom edges of the folded fabric. To prevent the strainer sleeve material from fraying, the strainer sleeve material was already folded and stitched about 1″ in in FIGS. 3B-D. This prevents wear on the strainer sleeve 114 where the bungee slides in and out of the strainer sleeve 114.

Referring to FIG. 3H, the strainer body 112 is produced. In some embodiments, about 22″ diameter circle is cut from the 5-micron nylon mesh.

Referring to FIGS. 3I-J, the strainer body 112 is sewn onto the strainer sleeve 114. The length of the strainer sleeve 114 wraps around the circumference of the strainer body 112. In some embodiments, there is about 1.5 inch to about 2 inch gab between the two distal ends of the strainer sleeve 114 when sewn along the circumference of the strainer body 112. In some embodiments, the strainer body 112 and the strainer sleeve 114 are stitched together with the strainer body 112 on the inside. The edge of the strainer body 112 is substantially even or slightly above the stitch on the strainer sleeve 114. The connecting stitch is placed about 0.125″ down from the stitch on the strainer sleeve 114 and the edge of the strainer body 112 as shown in FIG. 3J. This allows space above and below the stitch for the two be connected. In some embodiments, to avoid material fraying, the loose flap (e.g., of the strainer body 112 and/or strainer sleeve 114) is surged (e.g., undergoes surge stitching).

Referring to FIG. 3K, responsive to the strainer sleeve 114 being stitched to the strainer body 112, there is a gap between the distal ends of the strainer sleeve 114. The strainer body 112 and the strainer sleeve 114 may have wrinkles (e.g., without natural folds).

Referring to FIG. 3L, a fastener 116 (e.g., ¼″ nylon wrapped bungee cord) may be cut to an unstretched length of about 55 inches. The fastener 116 (e.g., ¼″ nylon wrapped bungee cord) may be threaded through the strainer top sleeve so that the distal portions of the bungee cord are hanging out of the strainer sleeve 114.

FIGS. 3M-P are completed with the fastener 116 already threaded through the strainer sleeve 114.

Referring to FIG. 3M, a first distal portion of the fastener 116 (e.g., bungee cord) is looped into a loose knot and a second distal portion of the fastener 116 is threaded through the knot (e.g., while the fastener 116 is in the strainer sleeve 114).

Referring to FIG. 3N, the knot is tightened around the second distal portion of the fastener 116. The knot is to be tight enough so that the second distal portion can slide through the knot by pulling the fastener 116 with a threshold force. If the knot is too loose, the fastener 116 may not hold the pre-filter device 110 tight against the container 120. If the knot is too tight, the fastener 116 may be difficult to adjust the pre-filter device 110 on the container 120. A threshold tightness is to be used.

Referring to FIG. 3O, after the knot is tightened, about 2″ length of fastener 116 is to be past the knot.

Referring to FIG. 3P, once the knot is tightened, each distal end of the fastener 116 is to be crimped. Zinc-plated steel or brass may be used to crimp the distal ends. The crimped ends are to be exposed to water, so a non-rusting material may be used. In some embodiments, instead of or in addition to crimping, the distal ends of the fastener may each be tied (e.g., end knots).

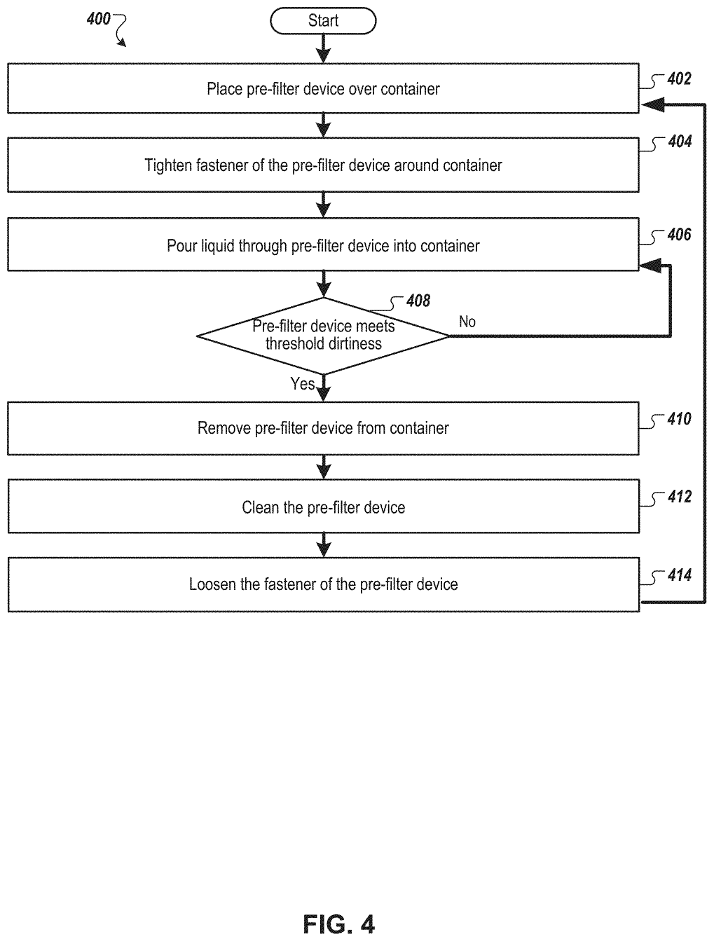

FIG. 4 illustrates a flow diagram of a method 400 associated with using a filtration system (e.g., system 100) including a pre-filter device (e.g., pre-filter device 110), according to certain embodiments. In some embodiments, method 400 is performed manually.

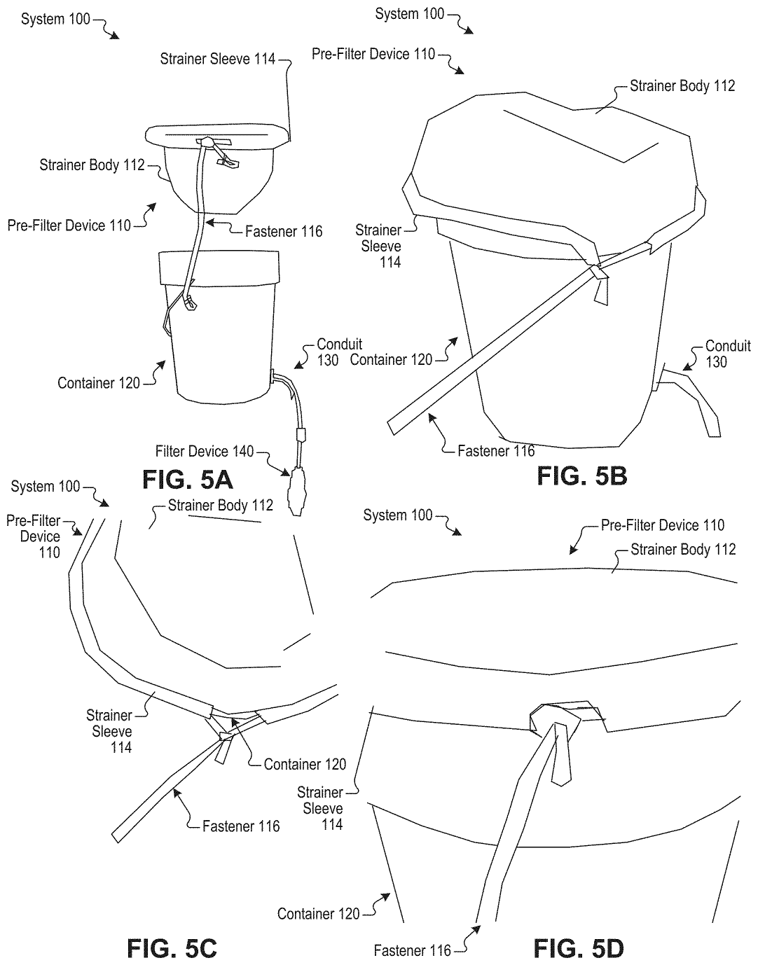

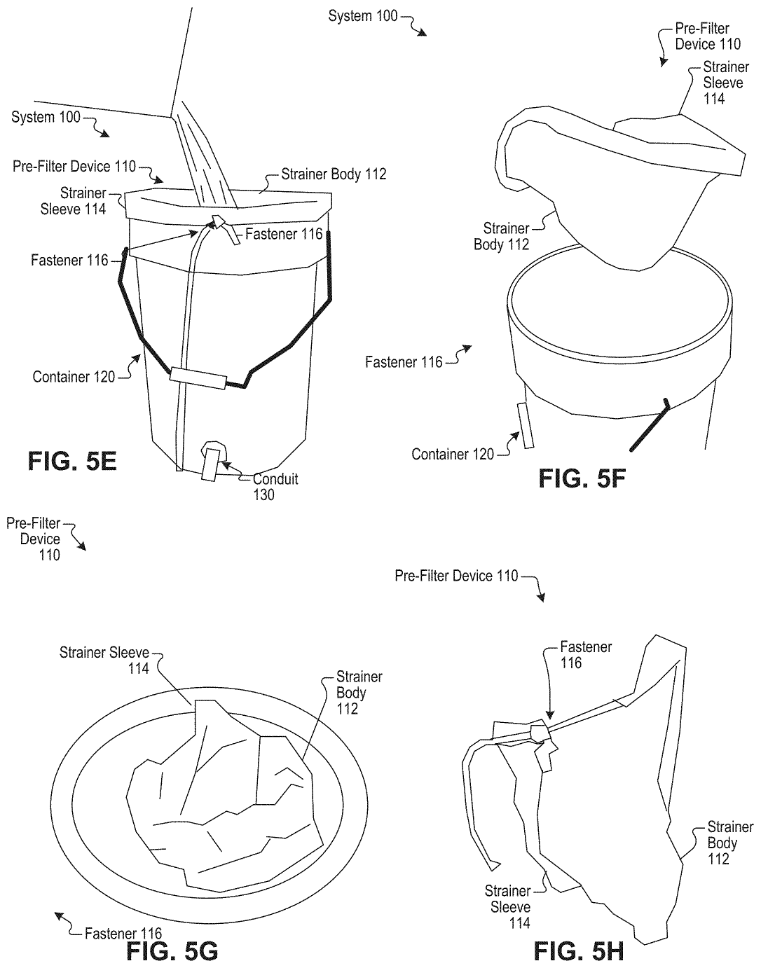

At block 402, the pre-filter device is placed over a container (see FIGS. 5A-B).

At block 404, a fastener of the pre-filter device is tightened around the container (e.g., see FIGS. 5C-D).

At block 406, liquid is poured through the pre-filter device into the container (e.g., see FIG. 5E).

At block 408, it is determined whether the pre-filter device meets threshold dirtiness. Responsive to the pre-filter device not meeting the threshold dirtiness, flow returns to block 406. Responsive to the pre-filter device meeting the threshold dirtiness, flow continues to block 410.

At block 410, the pre-filter device is removed from the container (e.g., see FIG. 5F).

At block 412, the pre-filter device is cleaned (e.g., see FIG. 5G). In some embodiments, pre-filter device is cleaned with liquid (e.g., strained water, pre-filtered water, filtered water, clean water, dirty water, any type of water). In some embodiments, the pre-filter device is cleaned by shaking the pre-filter device (e.g., responsive to turning pre-filter device inside-out, responsive to turning pre-filter device upside down). In some embodiments, the pre-filter device is cleaned by brushing contaminants off of the pre-filter device (e.g., responsive to turning pre-filter device inside-out, responsive to turning pre-filter device upside down).

At block 414, the fastener of the pre-filter device is loosened and flow returns to block 402 (e.g., see FIG. 5H).

FIGS. 5A-H illustrate use of a pre-filter device 110 of a system 100 (e.g., filtration system), according to certain embodiments.

FIG. 5A illustrates placing the pre-filter device 110 above a container 120 (e.g., bucket).

FIG. 5B illustrates placing the pre-filter device 110 on the container 120.

FIG. 5C illustrates tightening the fastener 116 (e.g., bungee cord) of the pre-filter device 110 responsive to the pre-filter device 110 being placed on the container 120.

FIG. 5D illustrates pre-filter device fastened to the container 120.

FIG. 5E illustrates pouring liquid (e.g., dirty water) through pre-filter device 110 into container 120.

FIG. 5F illustrates removing the pre-filter device 110 from the container 120 (e.g., responsive to the strainer becoming dirty).

FIG. 5G illustrates cleaning the pre-filter device 110 (e.g., in clean water). Cleaning the pre-filter device 110 removes contaminants (e.g., dirt) from the pre-filter device.

FIG. 5H illustrates loosening the fastener 116 (e.g., bungee cord) of the pre-filter device 110 to repeat FIGS. 5A-G.

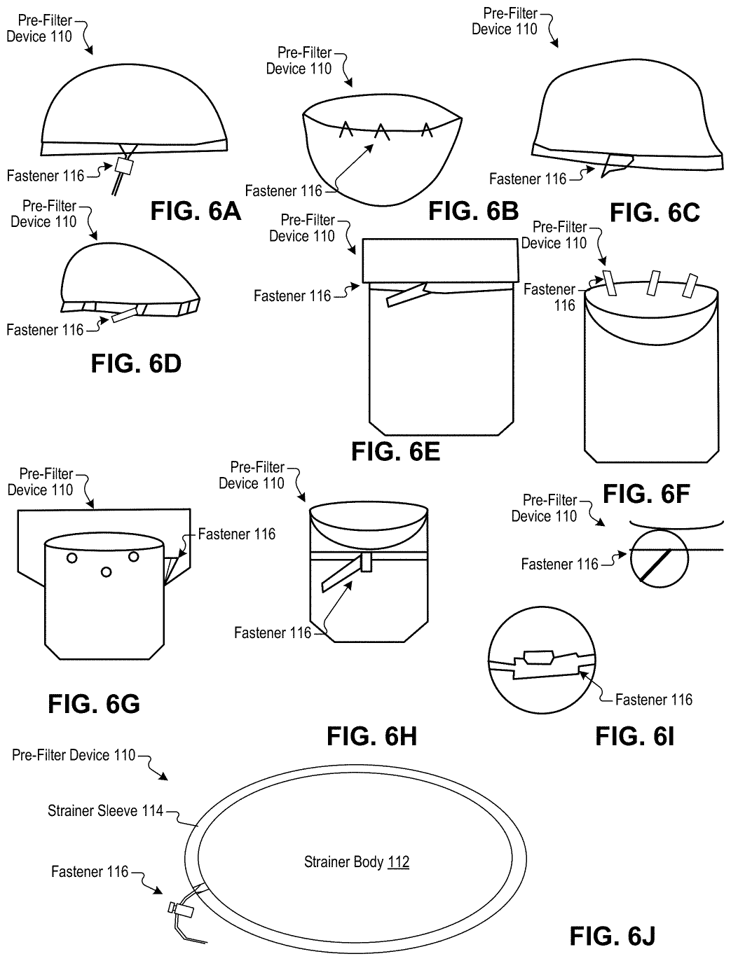

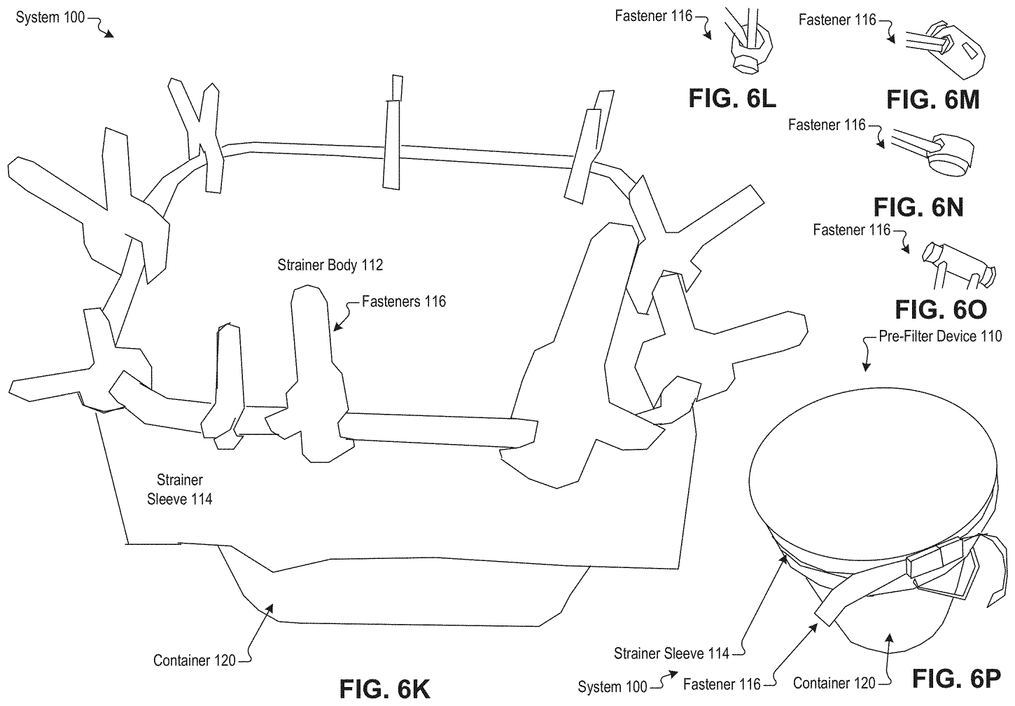

FIGS. 6A-P illustrate fasteners 116 of systems 100 (e.g., filtration systems), according to certain embodiments.

In some embodiments, to secure the pre-filter device 110 to container 120, a fastener 116 (e.g., tightening mechanism) is used. The fastener 116 may be a cord attached within a strainer sleeve 114 (e.g., sleeve of the nylon mesh) and that fits around an upper lip of a container 120 (e.g., bucket). The fastener 116 may be a bungee cord with a slip knot is used to provide a pre-filter device 110 that has a long life and to avoid mechanical failure of a connection piece. In some embodiments, different fasteners 116 may be used that may have different failure loads (e.g., amount of weight the pre-filter device 110 supports prior to failure) as shown in Table 2:

| Fastener 116 | Failure Load (lbs.) |
|---|---|
| Plastic Button with Paracord | 12 |
| Plastic Cord Lock with Paracord | 26.25 |
| Metal Button with Paracord | 20 |
| Metal Cord Lock with Paracord | 37.5 |
| D-ring with Belt | 55 |
| Buckle with Belt | 28.75 |
| ¼″ Bungee with Slip Knot | 50 |
| ¼″ Bungee with loop and hook | 40 |
| 5/16″ Bungee with Slip Knot | 55 |
| ⅜″ Bungee with Slip Knot | 75 |
| ½″ Bungee with Slip Knot | 100+ |

In some embodiments, a fastener 116 may be used that is not listed in Table 1.

In some embodiments, fastener 116 is a bungee cord (e.g., ¼ inch bungee cord) that allows a user to easily tighten the pre-filter device 110 around a container 120 and hold the pre-filter device 110 in place. In some embodiments, the fastener 116 may collapse inward once removed (e.g., fastener 116 is stretched when pre-filter device 110 is secured to the container 120 and fastener 116 reduces in diameter once pre-filter device 110 is removed from container 120) and hold excess liquid in place without spilling.

The fastener 116 may allow the pre-filter device 110 to be easy to use (e.g., quick to set up), to fit into a small bag for shipping, to be durable to withstand constant use, to hold with or without an edge flange for support, and/or to be compatible with different size and/or strengths of containers.

FIGS. 6A-I illustrate pre-filter devices 110 that have different types of fasteners 116.

FIG. 6A illustrates a pre-filter device 110 that has a fastener 116 that is a drawstring configured to tighten the pre-filter device 110 to a container 120.

FIG. 6B illustrates a pre-filter device 110 that has a fastener 116 that is a belt mechanism configured to tighten (e.g., like a belt) the pre-filter device 110 to a container 120. The fastener 116 may have fastening features on either side of the fastener (e.g., holes and belt buckle, hooks and loops, etc.).

FIG. 6C illustrates a pre-filter device 110 that has a fastener 116 that is a heating ventilation air conditioning (HVAC) connection (e.g., tension clamp, hose clamp, hose clamp that has thumb screws to change diameter of the clamp) configured to tighten the pre-filter device 110 to a container 120.

FIG. 6D illustrates a pre-filter device 110 that has a fastener 116 that is a tab clip configured to secure the pre-filter device 110 to a container 120 (e.g., fastener 116 clips over container 120 to tighten the material of the pre-filter device 110).

FIG. 6E illustrates a pre-filter device 110 that has a fastener 116 that is a belt that is configured to pass through slotted cutouts (e.g., belt loops, strainer sleeve 114) of pre-filter device 110 to tighten the pre-filter device 110 to a container 120.

FIG. 6F illustrates a pre-filter device 110 that has a fastener 116 that includes clamps (e.g., clothes pins) configured to secure (e.g., clamp, fasten) the pre-filter device 110 to a container 120.

FIG. 6G illustrates a pre-filter device 110 that has a fastener 116 that includes hooks secured to the strainer body 112 and/or strainer sleeve 114 to hook the pre-filter device 110 to a container 120 (e.g., to holes formed by the container 120).

FIG. 6H illustrates a pre-filter device 110 that has a fastener 116 that is a drawstring clip (e.g., drawstring with spring clip) configured to tighten (e.g., spring clip tighten) the pre-filter device 110 to a container 120. The fastener 116 may have a push button to tighten and/or release the fastener 116.

FIG. 6I illustrates a pre-filter device 110 that has a fastener 116 that is a drawstring with a friction plastic clip (e.g., strap length adjuster used to loosen and tighten backpack straps) configured to tighten the pre-filter device 110 to a container 120.

FIG. 6J illustrates a pre-filter device 110 that has a fastener 116 that is a drawstring with a plastic button lock (e.g., fastener 116 of a cinch sack). The fastener 116 (e.g., drawstring cord) may be sewn in a perimeter area (e.g., strainer sleeve 114).

FIG. 6K illustrates a pre-filter device 110 that has fasteners 116 that are clips.

FIG. 6L illustrates a pre-filter device 110 that has a fastener 116 that is a plastic button with a paracord.

FIG. 6M illustrates a pre-filter device 110 that has a fastener 116 that is a plastic cord lock with paracord.

FIG. 6N illustrates a pre-filter device 110 that has a fastener 116 that is a metal button with a paracord.

FIG. 6O illustrates a pre-filter device 110 that has a fastener 116 that is a metal cord lock with paracord.

FIG. 6P illustrates a pre-filter device 110 that has a fastener 116 that has a buckle.

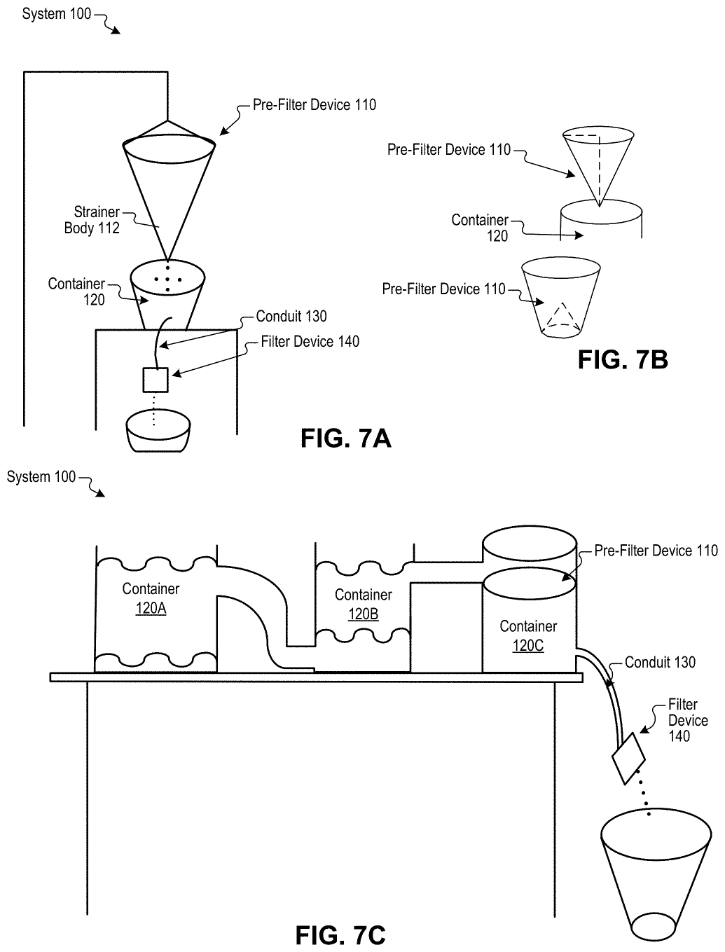

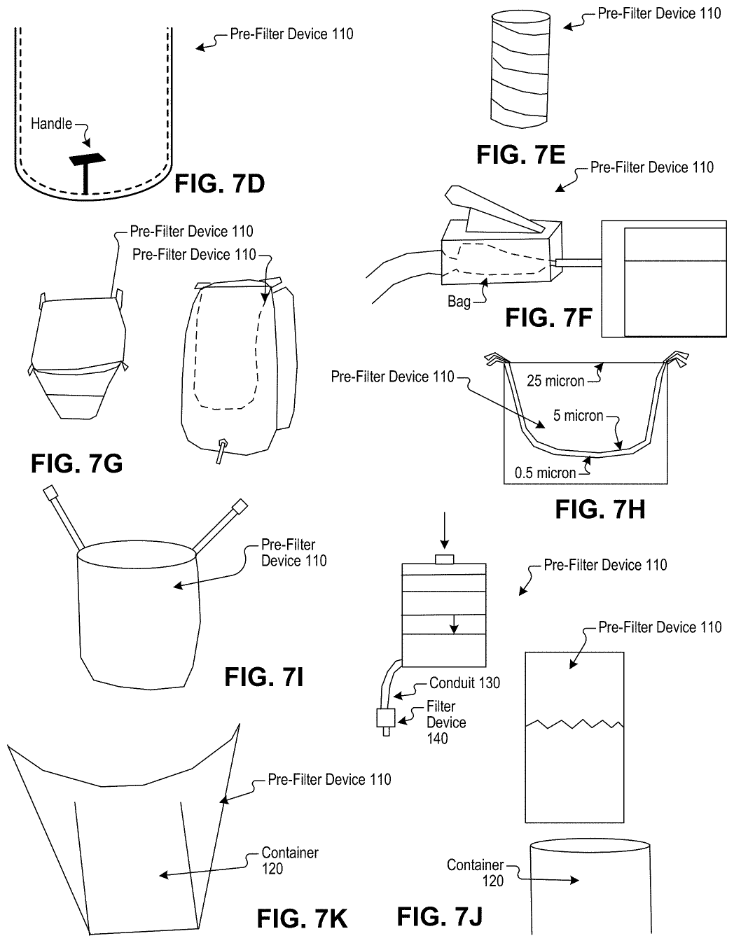

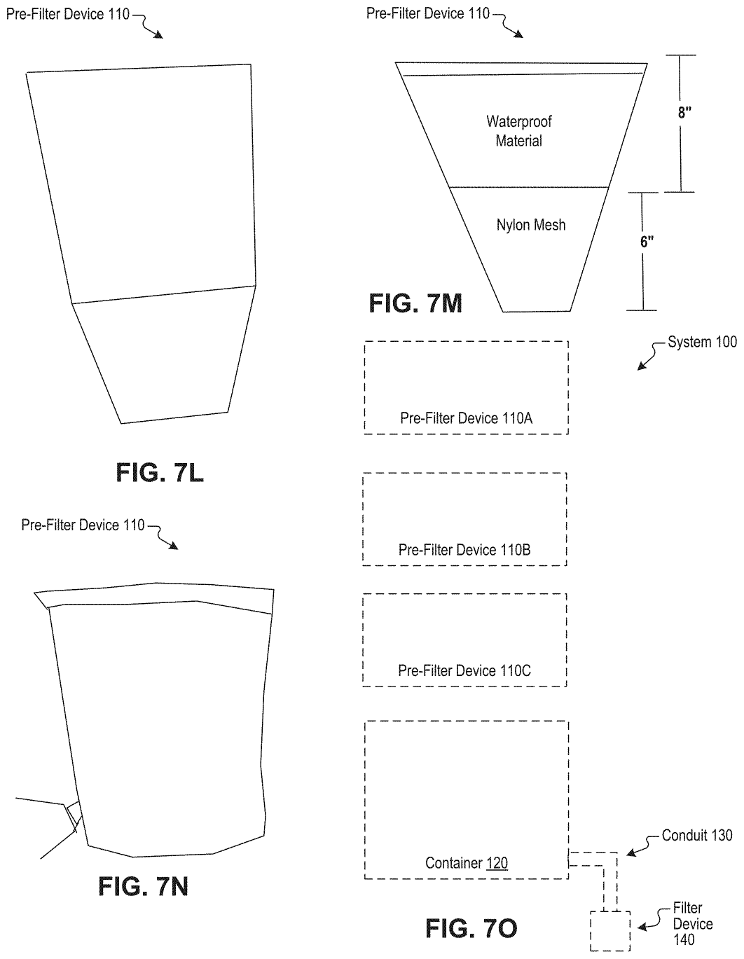

FIGS. 7A-O illustrate systems 100 (e.g., filtration systems) that include pre-filter devices 110, according to certain embodiments. One or more systems 100 of the present disclosure can include one or more features of FIGS. 7A-O.

FIG. 7A illustrates a filtration system 100 that uses a tree or tripod hanging structure. A tree or tripod is coupled to the pre-filter device 110 (e.g., via a rope, cord, hanging device, etc.). The pre-filter device 110 is suspended above the container 120. In some embodiments, this may increase flow with increased head pressure. In some embodiments, the pre-filter device 110 (e.g., the strainer body 112) has the shape of a hollow cone where the base of the cone is above the point of the cone. The strainer body 112 in the shape of a hollow cone may be made by taking a circular piece of material, cutting a sector (e.g., minor sector) from the circular piece of material (e.g., cutting from a first endpoint of an arc along a first radius of the circle to a center of the circle and from a second endpoint of the arch along a second radius of the circle to the center of the circle to remove a sector of the circle), and sewing the piece of material together (e.g., proximate the first radius where the circle was cut and the second radius where the circle was cut).

FIG. 7B illustrates a filtration system 100 that includes a pre-filter device 110 (e.g., strainer body 112) that is a hollow cone structure (e.g., similar to FIG. 7A). The pre-filter device 110 (e.g., strainer body 112) is a three-dimensional geometric shape that tapers (e.g., smoothly tapers) from a substantially flat base (e.g., circular base, rectangular base, triangular base, etc.) to a point (e.g., apex, vertex, point that is at a substantially right angle to the base). In some embodiments, the pre-filter device 110 is a truncated hollow cone. In some embodiments, the pre-filter device 110 is a hollow frustum of a cone. In some embodiments, pre-filter device 110 is a hollow cone where the distal end (e.g., pointed end) of the hollow cone is inverted into the frustum of the cone.

The hollow cone structure may provide more surface area for filtering liquid. The hollow cone structure may be suspended above container 120 to provide liquid flow through the pre-filter device 110.

FIG. 7C illustrates a system 100 (e.g., filtration system 100) that includes a weir (e.g., a series of weir settling containers). In some embodiments, multiple containers 120 (e.g., jars, buckets, etc.) are used as holding vessels for liquid (e.g., dirty water). The contaminants (e.g., particles) in the liquid settle to the bottom of one or more of the containers 120 and the top cleaner liquid is siphoned to the next container 120. This acts as a natural filter (e.g., each container 120 contains less sediment). A series of containers 120 may force the liquid to overcome the forces of gravity through a series of siphons. Contaminants (e.g., solid particles) denser than water accumulate at the bottoms of one or more containers 120 and lighten the filtration load on a pre-filter device 110 and/or a filter device 140. The siphons (e.g., conduits between containers 120) may be initially primed with clean water and then dirty water is introduced.

In some embodiments, an upper portion of container 120A is fluidly coupled to a lower portion of container 120B and an upper portion of container 120B is fluidly coupled to an upper portion of container 120C. Liquid may be introduced into container 120A where a first portion of first contaminants settle to a lower portion of container 120A and cleaner liquid flows from an upper portion of container 120A to a lower portion of container 120B. Second contaminants may settle in container 120B and cleaner liquid flows from an upper portion of container 120B to container 120B. In some embodiments, the cleaner liquid flowing from container 120B into container 120C flows through a pre-filter device 110 disposed in container 120C.

In some embodiments, different amount of containers 120 than those shown in FIG. 7C are used. In some embodiments, containers 120 are fluidly coupled different than shown in FIG. 7C. In some embodiments, one or more pre-filter devices 110 are included in different containers 120 or different locations than shown in FIG. 7C.

FIG. 7D illustrates a filtration system 100 including a pre-filter device 110 that includes a liner (e.g., mud cake layer). The pre-filter device 110 may include at least a two tiered-layer system. A draw string, pull-string, handle, and/or the like is coupled to the top layer. When contaminants (e.g., mud) start to cake on the pre-filter device 110, the draw string is used to pull the layer and to clean the contaminants from the surface. The top layer may be a liner that is configured to quickly remove contaminants (e.g., mud cakes) from the inside of the pre-filter device 110 by having a draw handle on the liner (e.g., top layer). The top layer may have a larger opening size (e.g., 25-micron liner) than the bottom layer (e.g., 0.5 micron, 5 micron, etc.).

FIG. 7E illustrates a filtration system 100 including a pre-filter device 110 that is a centrifugal filter. The pre-filter device 110 includes a cylindrical fabric with a skeleton structure used with spiral grooving for water flow. In some embodiments, the cylindrical flow of water against outside filtering fabric creates higher pressure and/or flow rate through the medium (e.g., exterior mesh, pre-filter device 110). The pre-filter device 110 uses gravity and momentum to push water through the medium. To wash the pre-filter device 110, the interior wall (e.g., skeleton structure) may be removed.

FIG. 7F illustrates a filtration system 100 including a pre-filter device 110 that includes a hand pump. In some embodiments, a hand pump device is used to push water through tubes or fabric. This allows a user to create pressure in the system to increase flow rate through the fabric of the pre-filter device 110.

FIG. 7G illustrates a filtration system 100 including a pre-filter device 110 that has a draw string. The pre-filter device 110 may be a strainer bag that can be cinched or closed at an upper portion. Once the strainer bag is cinched or closed, the strainer bag may be pushed down (e.g., by a user) to push the liquid (e.g., pre-filtered water) out the sides of the bag. In some embodiments, this increases flow rate through the strainer bag.

FIG. 7H illustrates a filtration system 100 including a pre-filter device 110 that has tiered layers. The pre-filter device 110 includes fabric of different sized openings combined together. The multi-layered fabric assemble may have the largest micron opening at the top layer and the smallest layer micron opening at the bottom (e.g., fabric with 25 micron openings on top, fabric with 5 micron openings in the middle, and fabric 0.5 micron openings on the bottom).

FIG. 7I illustrates a filtration system 100 including a pre-filter device 110 (e.g., strainer bag) that feeds into a filter device 140. A strainer bag may be used instead of a container 120 to collect liquid and feed the liquid to filter device 140 (e.g., bacteria filter). The strainer bag may be suspended to create height (e.g., head).

FIG. 7J illustrates a filtration system 100 including a pre-filter device 110 that includes a plunger. A mechanical plunger may be used to push liquid through the strainer body 112. The plunger may be detachable from housing for liquid (e.g., dirty water) to be poured into the pre-filter device 110.

FIG. 7K illustrates a filtration system 100 including a pre-filter device 110 that is a fabric bag. The pre-filter device 110 may be a large piece of fabric suspended over one or more containers 120 (e.g., one or more buckets). The fabric may be attached by a support system (e.g., tripod system, pole system) to the one or more containers 120.

FIGS. 7L-N illustrate filtration systems 100 that include pre-filter devices 110 that are bag-type systems. The pre-filter device 110 may use a mesh material (e.g., 5-micron nylon mesh material) to filter liquid. The mesh material may be sewn in a cone shape at the bottom of the pre-filter device 110. The upper portion of the pre-filter device 110 may be made of a waterproof material. The upper portion may be configured to fit over a variety of different sizes of buckets with a fastener 116 (e.g., drawstring) to tighten and hold in place the pre-filter device 110. The pre-filter device 110 may be configured to be used as a gravity-fed system by rolling the upper portion around the top end of a container 120 (e.g., bucket) and tightening (e.g., cinching tight) the pre-filter device 110 to the container 120. To have an increased flow rate, the pre-filter device 110 (e.g., bag) may be removed from the rim of the container 120 and rolled down as shown in FIG. 7N to add head pressure and move the filtered water quickly through the mesh (e.g., nylon membrane).

In some embodiments, pre-filter device 110 is a bag configured to be placed on a container 120, hung above a container 120, and/or squeezed. In some embodiments, FIG. 7N illustrates a dry bag that is coupled to (e.g., includes) a pre-filter device 110.

Referring to FIG. 7O, in some embodiments, multiple pre-filter devices 110 (e.g., strainer bodies 112) are used. The pre-filter device 110 with the largest openings may be furthest upstream from filter device 140 highest and the pre-filter device 110 with the smallest openings may be the closest to the filter device 140. In some embodiments, pre-filter device 110A may be a 25-micron nylon mesh bag, pre-filter device 110B may be a 1-micron polyester felt bag, and pre-filter device 110C may be a 0.5 micron polyester filter bag. Different numbers of pre-filter devices 110 of different sized openings and different materials may be used. Sediment may settle at the bottom of the pre-filter device 110A and allow water to slowly seep through which causes the water to be filtered by sand first and then through the pre-filter device 110A (e.g., 25-micron nylon mesh).

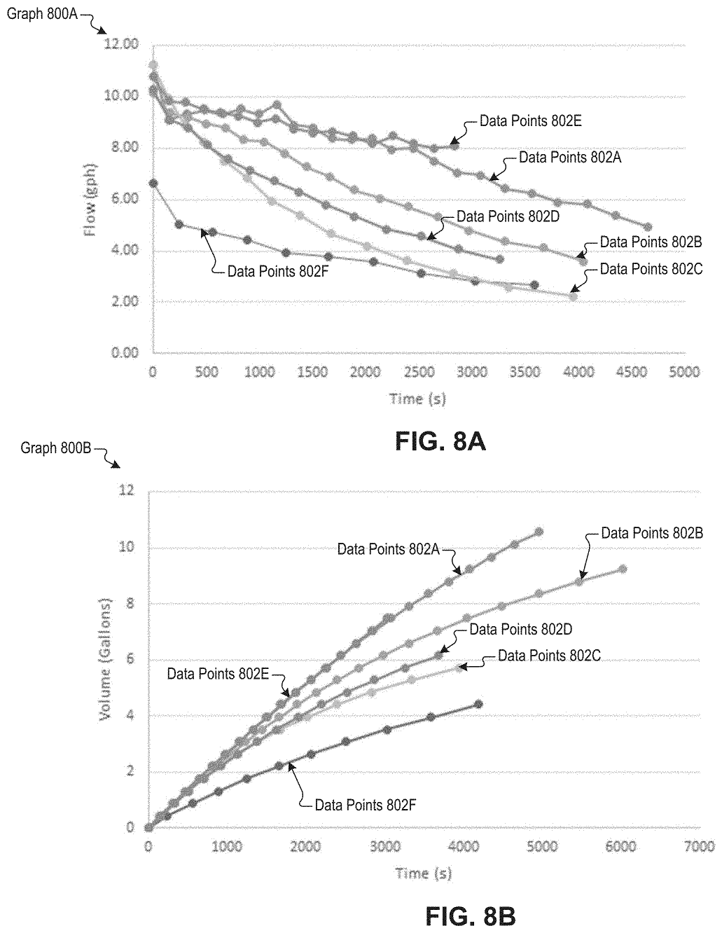

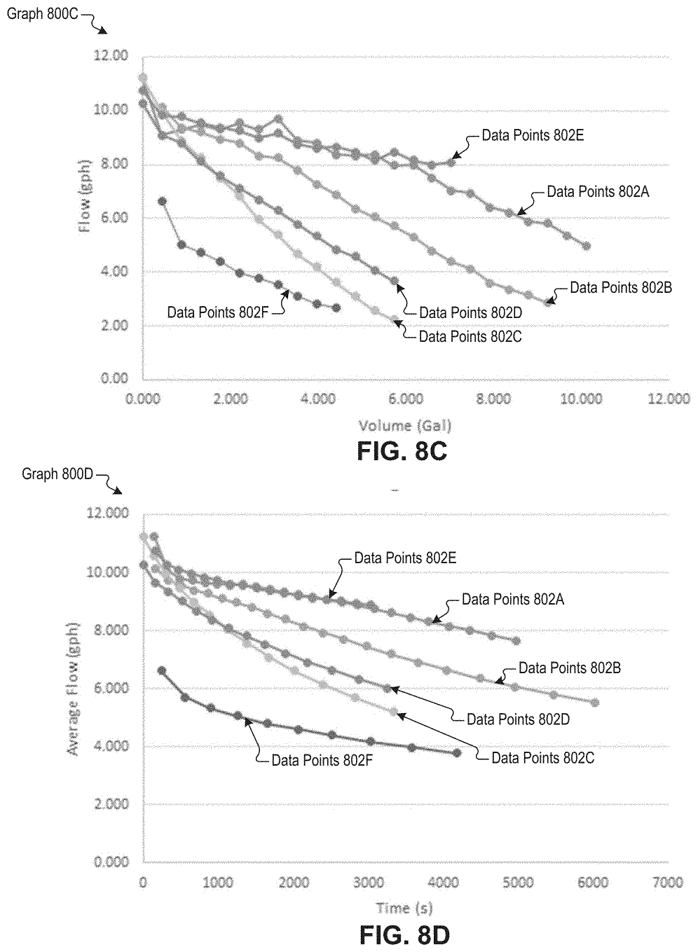

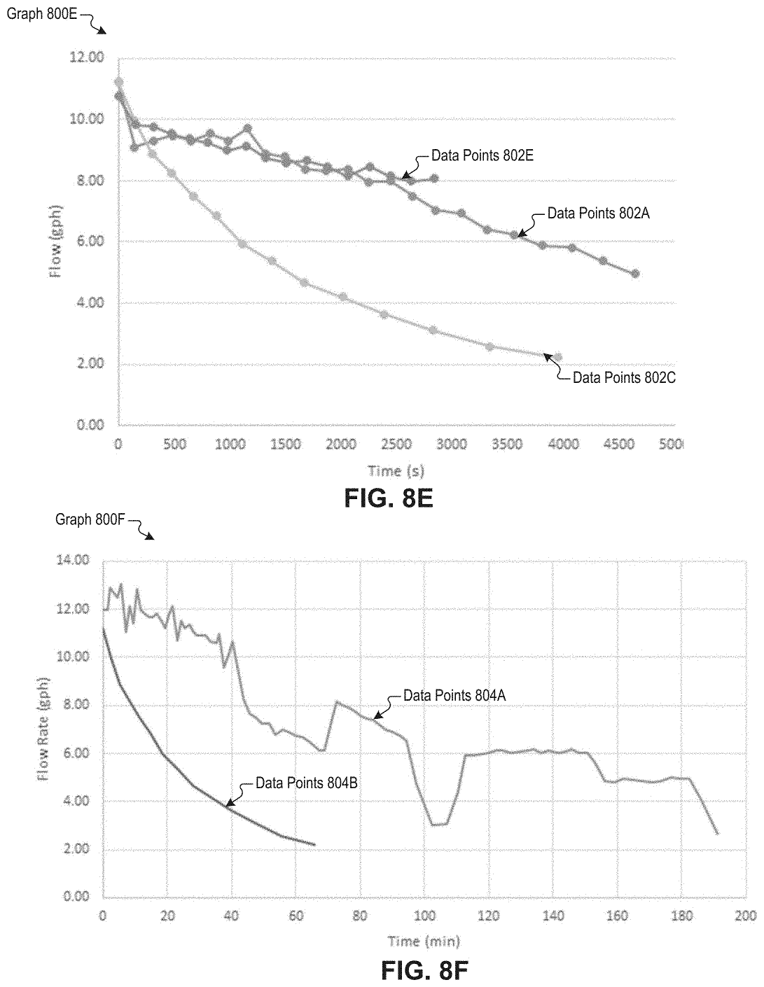

FIGS. 8A-F illustrate graphs 800A-F associated with filtration systems (e.g., systems 100), according to certain embodiments.

FIG. 8A illustrates a graph 800A depicting flow rate (gph) compared to time (seconds) for water of system 100 exiting the filter device 140 (e.g., after passing through a pre-filter device 110 or without passing through a pre-filter device 110).

FIG. 8B illustrates a graph 800B depicting total volume (gallons) compared to time (seconds) for water of system 100 exiting the filter device 140 (e.g., after passing through a pre-filter device 110 or without passing through a pre-filter device 110).

FIG. 8C illustrates a graph 800C depicting flow rate (gph) compared to volume (gallons) for water of system 100 exiting the filter device 140 (e.g., after passing through a pre-filter device 110 or without passing through a pre-filter device 110).

FIG. 8D illustrates a graph 800D depicting average flow rate (gph) compared to time (seconds) for water of system 100 exiting the filter device 140 (e.g., after passing through a pre-filter device 110 or without passing through a pre-filter device 110).

FIG. 8E illustrates a graph 800E depicting flow (gph) compared to time (seconds) for water of system 100 exiting the filter device 140 (e.g., after passing through a pre-filter device 110 or without passing through a pre-filter device 110).

Data points 802A are the flow rate through the filter device 140 over time using a pre-filter device 110 that includes a 25-micron filter layer and a 5-micron filter layer.

Data points 802B are the flow rate through the filter device 140 over time using a pre-filter device 110 that includes two 25-micron filter layers.

Data points 802C are the flow rate through the filter device 140 over time without using a pre-filter device 110.

Data points 802D are the flow rate through the filter device 140 over time using a pre-filter device 110 that includes a 10-micron filter layer.

Data points 802E are the flow rate through the filter device 140 over time using a pre-filter device 110 that includes a 5-micron filter layer.

Data points 802F are the flow rate through the filter device 140 over time using a pre-filter device 110 that includes a 25-micron filter layer.

As shown in graph 800A, a pre-filter device 110 using a 5-micron fabric significantly improves life of filter device 140. Comparing data points 802C (e.g., performance of filter device 140 without a pre-filter device 110) and data points 802E (e.g., performance of filter device 140 using a pre-filter device 110 that has a 5-micron fabric) shows that volume filtered before performing a backflush of filter device 140 can improve by 3-times with implementation of a pre-filter device 110 that has a 5-micron fabric.

As shown in graph 800B, a pre-filter device 110 using a 5-micron fabric provides more total volume of filtered water than the other fabric types.

As shown in graph 800C, a pre-filter device 110 using a 5-micron fabric provides more flow per volume than the other fabric types.

As shown in graph 800D, a pre-filter device 110 using a 5-micron fabric provides a higher average flow rate over time of filtered water than the other fabric types.

As shown in graph 800E, a pre-filter device 110 using a 5-micron fabric provides a higher flow over time than the other fabric types.

Referring to FIG. 8F, graph 800F depicts flow rate (gph) compared to time (minutes) for water of system 100 exiting the filter device 140. Data points 804A illustrate flow rate through filter device 140 after passing through pre-filter device 110. Data points 804B illustrate flow rate through filter device 140 without passing through pre-filter device 110. As shown in graph 800F, comparing the measured instantaneous flowrate to time shows how clogged the filter device 140 is as more liquid is filtered.

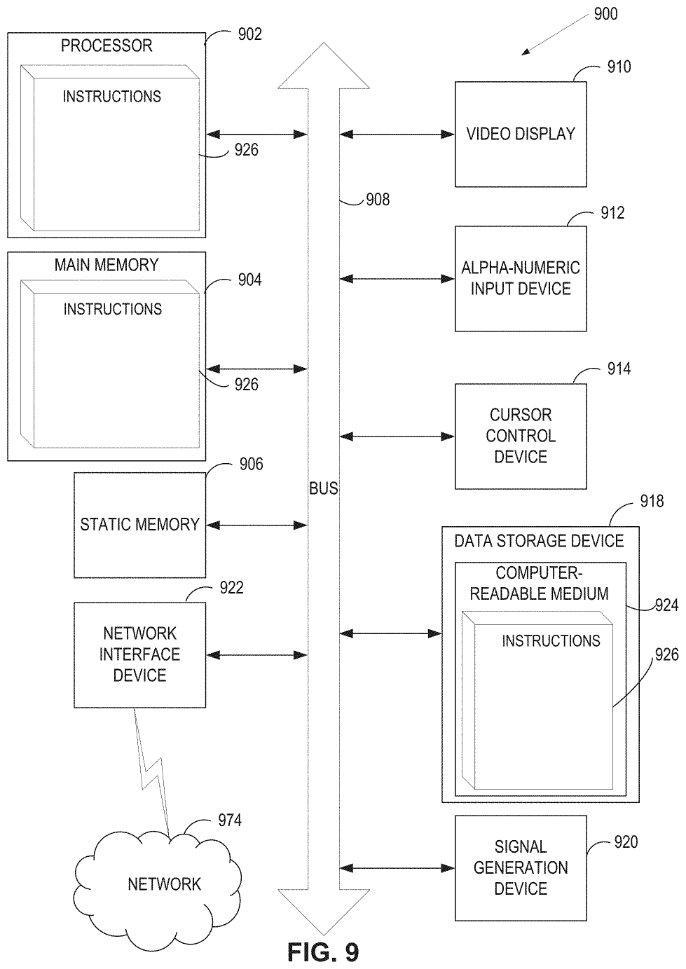

FIG. 9 is a block diagram illustrating a computer system 900, according to certain embodiments. In some embodiments, the computer system 900 performs one or more methods described herein. Computer system 900 may include processing logic, a processing device, a controller, manufacturing equipment, sewing equipment, cutting equipment, and/or the like.

In some embodiments, computer system 900 is connected (e.g., via a network, such as a Local Area Network (LAN), an intranet, an extranet, or the Internet) to other computer systems. In some embodiments, computer system 900 operates in the capacity of a server or a client computer in a client-server environment, or as a peer computer in a peer-to-peer or distributed network environment. In some embodiments, computer system 900 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 900 includes a processing device 902, a volatile memory 904 (e.g., Random Access Memory (RAM)), a non-volatile memory 906 (e.g., Read-Only Memory (ROM) or Electrically-Erasable Programmable ROM (EEPROM)), and a data storage device 916, which communicate with each other via a bus 908.

In some embodiments, processing device 902 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 900 further includes a network interface device 922 (e.g., coupled to network 974). In some embodiments, computer system 900 also includes a video display unit 910 (e.g., an LCD), an alphanumeric input device 912 (e.g., a keyboard), a cursor control device 914 (e.g., a mouse), and a signal generation device 920.

In some implementations, data storage device 916 includes a non-transitory computer-readable storage medium 924 on which store instructions 926 encoding any one or more of the methods or functions described herein, including instructions for implementing methods described herein.

In some embodiments, instructions 926 also reside, completely or partially, within volatile memory 904 and/or within processing device 902 during execution thereof by computer system 900, hence, in some embodiments, volatile memory 904 and processing device 902 also constitute machine-readable storage media.

While computer-readable storage medium 924 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “cutting,” “removing,” “folding,” “sewing,” “stitching,” “passing,” “coupling,” “securing,” “actuating,” “receiving,” “providing,” “obtaining,” “determining,” “identifying,” “causing,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±20%, ±15%, ±10%, ±5%, ±4%, ±3%, ±2%, ±1%, and/or the like (e.g., a range can be made around the dimensions shown).

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A filtration system comprising:
a pre-filter device configured to strain contaminants from liquid, the pre-filter device comprising:
a strainer body;
a strainer sleeve secured to the strainer body; and
a fastener configured to pass through the strainer sleeve to secure the pre-filter device to a container.

2. The filtration system of claim 1 further comprising a filter device fluidly coupled to the container, wherein the filter device is configured to further filter the liquid responsive to the contaminants being strained from the liquid via the pre-filter device.

3. The filtration system of claim 2 further comprising a valve disposed between the container and the filter device.

4. The filtration system of claim 2, wherein the filter device comprises filter membranes configured to filter additional contaminants from the liquid.

5. The filtration system of claim 4, wherein:
the contaminants are at least about 5 microns in width and are to be removed from the liquid via the pre-filter device; and
the additional contaminants are about 0.1 microns to about 5 microns in width and are to be removed from the liquid by the filter device.

6. The filtration system of claim 1, wherein the fastener comprises a cord, and wherein distal portions of the cord are to be secured together responsive to the fastener being passed through the strainer sleeve.

7. The filtration system of claim 6, wherein the cord is a bungee cord, wherein the distal portions are secured together via a slip knot tied on a first distal end of the bungee cord and a second distal end of the bungee cord being fed through the slip knot.

8. The filtration system of claim 1, wherein the strainer body is a circular shape that bulges when the liquid is poured onto the pre-filter device to create a pseudo-half-sphere shape.

9. The filtration system of claim 1, wherein the strainer body comprises nylon mesh that has openings of about 30 microns or less and is configured to filter the contaminants larger than 30 microns.

10. The filtration system of claim 1, wherein the strainer body comprises nylon mesh that has openings of about 7 microns or less and is configured to filter the contaminants larger than 7 microns.

11. The filtration system of claim 1, wherein the strainer body comprises nylon mesh that has openings of about 5 microns or less and is configured to filter the contaminants larger than 5 microns.

12. The filtration system of claim 1, wherein:
the container is a bucket that has a bottom wall and one or more sidewalls;
an upper portion of the bucket forms a lip;
the pre-filter device is configured to be secured to the lip of the container;
a lower portion of the bucket forms an opening; and
a filter device is configured to fluidly couple to the bucket via the opening.

13. A pre-filter device comprising:
a strainer body;
a strainer sleeve secured to the strainer body; and
a fastener configured to pass through the strainer sleeve to secure the pre-filter device to a container, wherein the pre-filter device is configured to strain contaminants from liquid.

14. The pre-filter device of claim 13, wherein the fastener comprises a cord, and wherein distal portions of the cord are to be secured together responsive to the fastener being passed through the strainer sleeve.

15. The pre-filter device of claim 14, wherein the cord is a bungee cord, wherein the distal portions are secured together via a slip knot tied on a first distal end of the bungee cord and a second distal end of the bungee cord being fed through the slip knot.

16. The pre-filter device of claim 13, wherein the strainer body comprises nylon mesh that has openings of about 7 microns or less and is configured to filter the contaminants larger than 7 microns.

17. A method comprising:
causing a strainer sleeve of a pre-filter device to be sewn to a strainer body of the pre-filter device;
causing a fastener of the pre-filter device to be passed through the strainer sleeve; and
causing distal portions of the fastener to be coupled to each other, wherein the pre-filter device is configured to be secured to a container via the fastener and to strain contaminants from liquid.

18. The method of claim 17 further comprising:
responsive to a first distal end of a strainer sleeve material being folded and a second distal end of the strainer sleeve material being folded, causing the first distal end of the strainer sleeve material to be sewn and the second distal end of the strainer sleeve material to be sewn; and
responsive to the strainer sleeve material being folded longitudinally, causing the strainer sleeve material to be sewn longitudinally proximate an edge of the strainer sleeve material to form the strainer sleeve.

19. The method of claim 17, wherein the fastener is a bungee cord, and wherein distal of the bungee cord are secured together via a slip knot tied on a first distal end of the bungee cord and a second distal end of the bungee cord being fed through the slip knot.

20. The method of claim 17, wherein the strainer body comprises nylon mesh that has openings of about 7 microns or less and is configured to filter the contaminants larger than 7 microns.
